(19) United States
(12) Patent Application Publication
(10) Pub. No.: US 2026/0236098 A1
(43) Pub. Date: Aug. 13, 2026

(54) TRANSPARENT CIRCUITRY FOR NEAR-EYE OPTICS

(71) Applicant: Meta Platforms Technologies, LLC, Menlo Park, CA (US)

(72) Inventors: Shermin Arab, East Palo Alto, CA (US); Karol Constantine Hatzilias, Sammamish, WA (US); Liliana Ruiz Diaz, Seattle, WA (US); Andrew John Ouderkirk, Kirkland, WA (US)

(21) Appl. No.: 19/536,671

(22) Filed: Feb. 11, 2026

Related U.S. Application Data
(60) Provisional application No. 63/757,602, filed on Feb. 12, 2025.

(51) Int. Cl. G06F 3/01

(52) U.S. Cl. CPC G06F 3/014

(57) ABSTRACT

An ophthalmic lens assembly includes a transparent ophthalmic substrate with a transparent conductive coating on the substrate. The transparent conductive coating is patterned into at least one conductive island that is configured as an electrode, has a non-geometrically defined shape, and is separated from adjacent conductive material by an insulating gap. Various other aspects are also disclosed.

### CROSS REFERENCE TO RELATED APPLICATION

This application is a non-provisional of and claims the benefit of and priority to U.S. Provisional Application No. 63/757,602, filed Feb. 12, 2025, the disclosure of which is incorporated herein in its entirety by this reference.

### SUMMARY

An ophthalmic lens assembly is disclosed that features a transparent ophthalmic substrate with a transparent conductive coating patterned into at least one conductive island. Each conductive island is shaped in a non-geometric manner, functions as an electrode, and is separated from adjacent conductive material by an insulating gap.

A method of manufacturing an ophthalmic lens assembly is also described. The process involves providing a transparent ophthalmic substrate and patterning a transparent conductive coating on the substrate to define at least one conductive island with a non-geometric shape that serves as an electrode. The method further includes creating at least one adjacent conductive island so that an insulating gap remains between conductive regions.

Additionally, an eyewear device is presented that includes a frame supporting at least one ophthalmic lens assembly. The lens assembly features a transparent ophthalmic substrate and a transparent conductive coating patterned into at least one conductive island with a non-geometric shape. The conductive island is separated from adjacent conductive material by an insulating gap, which provides electrical isolation while maintaining see-through transparency in the wearer's field of view.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic diagram illustrating a patterned substrate with conductive paths and electrode spacing according to some embodiments of this disclosure.

FIG. 2 is a schematic depiction illustrating a transparent conductive electrode patterned on a substrate according to some embodiments of this disclosure.

FIG. 3 is a schematic depiction illustrating a patterned substrate, including a zoomed section highlighting non-geometrically defined conductive islands and insulating gaps according to some embodiments of this disclosure.

FIG. 4 is a schematic diagram illustrating a patterned substrate design featuring non-geometrically defined conductive regions, and a zoomed section of a boundary, according to some embodiments of this disclosure.

FIG. 5 is a schematic depiction illustrating the surface area of a transparent conductive electrode on a substrate, according to some embodiments of this disclosure.

FIG. 6 is a system diagram illustrating transparent circuitry with interconnected components, including electronic chips, bond pads, metal traces, transparent conductor electrodes, and a transparent substrate according to some embodiments of this disclosure.

FIG. 7 is a schematic illustration depicting the layered structure of transparent circuitry, including a transparent substrate, conductive coating, adhesion layer, and metal contacts according to some embodiments of this disclosure.

FIG. 8 is a diagram illustrating a lens with labeled components for transparent circuitry applications according to some embodiments of this disclosure.

FIG. 9 is a flow diagram of an exemplary method for manufacturing an ophthalmic device according to embodiments of this disclosure.

FIG. 10 is an illustration of an example artificial-reality system according to some embodiments of this disclosure.

FIG. 11 is an illustration of an example artificial-reality system with a handheld device according to some embodiments of this disclosure.

FIG. 12A is an illustration of example user interactions within an artificial-reality system according to some embodiments of this disclosure.

FIG. 12B is an illustration of example user interactions within an artificial-reality system according to some embodiments of this disclosure.

FIG. 13A is an illustration of example user interactions within an artificial-reality system according to some embodiments of this disclosure.

FIG. 13B is an illustration of example user interactions within an artificial-reality system according to some embodiments of this disclosure.

FIG. 14 is an illustration of an example wrist-wearable device of an artificial-reality system according to some embodiments of this disclosure.

FIG. 15 is an illustration of an example wearable artificial-reality system according to some embodiments of this disclosure.

FIG. 16 is an illustration of an example augmented-reality system according to some embodiments of this disclosure.

FIG. 17A is an illustration of an example virtual-reality system according to some embodiments of this disclosure.

FIG. 17B is an illustration of another perspective of the virtual-reality systems shown in FIG. 17A.

FIG. 18 is a block diagram showing system components of example artificial- and virtual-reality systems.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The field of near-eye optics, particularly in the context of augmented reality eyewear and smart glasses, faces significant challenges in integrating electronic circuitry directly onto ophthalmic lenses without degrading optical performance or user experience. Conventional approaches typically employ visible metal traces or opaque interconnects, which obstruct the user's field of view and introduce undesirable visual artifacts such as reflections, rainbow effects, and local waviness. These artifacts not only diminish see-through transparency but also make the circuitry conspicuous to both the wearer and outside observers, thereby reducing the social acceptability of such devices. Furthermore, traditional interconnect designs, which often utilize long and narrow conductive lines, are unable to provide the necessary balance between electrical conductivity and optical clarity, resulting in limited integration of sensors and electronic components within the lens area.

To address these limitations, the present disclosure provides transparent circuitry for ophthalmic lenses by utilizing free-form, non-geometrically patterned conductive islands as electrodes. These conductive islands are formed from a transparent conductive coating that is patterned into non-geometric shapes and separated by variable-width insulating gaps. This configuration ensures electrical isolation between adjacent conductive regions while maintaining high optical transmission (e.g., at least 90% in the visible spectrum) and low haze (e.g., below 1%), thereby preserving the see-through quality of the lens. The transparent conductive coating is engineered to achieve low sheet resistance (e.g., less than 15 ohms per square), enabling reliable electrical performance without the need for visible metal traces. The non-geometric patterning and variable gap spacing minimize visual conspicuity and eliminate sharp edges, further enhancing the optical uniformity and user experience.

Some aspects further incorporate specialized layout optimization methods to define the shape, size, and spacing of the conductive islands. These methods are configured to maximize the usable surface area of the transparent substrate while minimizing electrical resistance and ensuring that the insulating gaps are sufficient to prevent electrical crosstalk. The process involves blanket deposition of the transparent conductive coating, followed by precision patterning and etching to create the free-form islands. An adhesive layer, such as titanium, may be deposited between the substrate and the conductive coating to improve adhesion and durability. Additionally, the insulating gaps between conductive islands can be filled with index-matching materials to maintain optical uniformity across the lens. The conductive islands are designed to support the integration of electronic components, such as sensors or detectors, which are electrically coupled to the islands via metal-to-metal flip-chip bonding techniques. This approach enables the direct integration of functional electronic elements within the user's field of view while maintaining the desired optical and electrical properties of the lens assembly.

By implementing these transparent circuitry techniques, the described subject matter expands the available real estate for electronic integration on ophthalmic lenses, allowing for the placement of sensors and other components directly within the field of view without compromising transparency, aesthetics, or device performance. This approach meets the stringent requirements for see-through AR eyewear and smart glasses, providing a solution that is both functionally robust and visually unobtrusive, and represents a significant advancement in the field of near-eye optics.

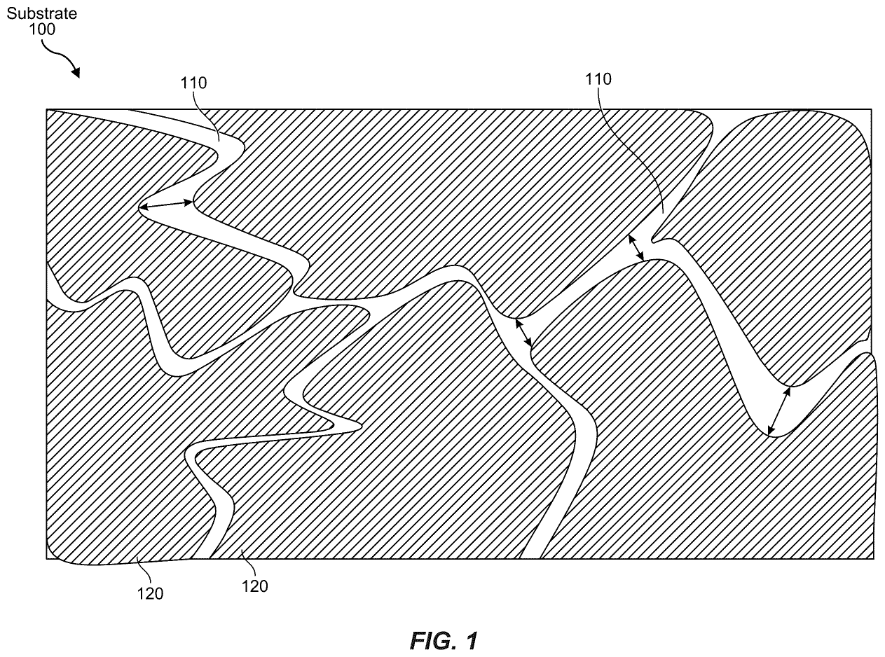

FIG. 1 illustrates an ophthalmic lens assembly in which a transparent ophthalmic substrate 100 supports a transparent conductive coating patterned into conductive islands 120 separated by insulating gaps 110.

As used herein, a transparent ophthalmic substrate is a lens or lens precursor configured for near-eye use that transmits visible light and provides mechanical support for circuitry. The substrate may comprise glass, polycarbonate, cyclic olefin polymer or copolymer, acrylic, polyurethane, or other transparent plastics or composites. The substrate may further include anti-reflective, hard-coated, or anti-smudge layers. The substrate thickness may be 200-800 micrometers. The substrate thickness may be 300-600 micrometers. The substrate thickness may be less than 500 micrometers.

A transparent conductive coating is a film that conducts electricity while maintaining optical transmission across the visible spectrum and is patterned here to form the conductive islands 120. Suitable materials include transparent conductive oxides such as indium tin oxide (ITO), indium zinc oxide (IZO), aluminum-doped zinc oxide (AZO), or fluorine-doped tin oxide (FTO). Alternatives include metal nanowire networks (silver, copper, gold), graphene, carbon-nanotube meshes, conductive polymers such as PEDOT:PSS, ultrathin metallic grids, or hybrid stacks combining TCO and metal. The transparent conductive coating thickness may be 50-300 nanometers. The transparent conductive coating thickness may be 100-150 nanometers. The transparent conductive coating thickness may be less than 200 nanometers. Deposition may be by sputtering, evaporation, atomic layer deposition, solution coating, or printing followed by patterning and etching.

Each conductive island 120 is configured as an electrode, meaning it provides a contact surface to inject or collect charge or convey signals to an electronic component such as a sensor, photodiode, light emitter, detector, heater, antenna, or indicator. The conductive island has a non-geometrically defined shape, meaning its boundary is free-form rather than constrained to straight edges or regular polygons to reduce visual artifacts and conspicuity. In certain embodiments, a minimum local radius of curvature along the island boundary exceeds 2 micrometers. The minimum local radius of curvature may be 2-20 micrometers. The minimum local radius of curvature may be at least 5 micrometers. Boundaries may include micro-wiggles or dithering to break straight edges, and islands may be continuous or segmented while remaining electrically isolated by gaps 110.

Insulating gaps 110 are regions that separate adjacent conductive islands 120 to provide electrical isolation and may be voids or filled with dielectric material. Suitable gap dielectrics include UV-curable acrylates, silicones, sol-gel oxides, urethane acrylates, or other index-matching materials formulated to reduce refractive-index discontinuities between substrate 100 and the conductive coating. The insulating gap width may vary to satisfy isolation and bonding requirements. The minimum gap width may be 20-100 micrometers. The minimum gap width may be 35-50 micrometers. A total area of insulating gaps relative to a corresponding island may be less than 5%. The total gap area may be less than 2%. The total gap area may be less than 1%.

Conductive islands 120 may include or terminate at bond pads positioned within the patterned region to facilitate attachment of an electronic component. Bond pads are localized conductive areas compatible with flip-chip bonding, wire bonding, anisotropic conductive film, or solder bump attachment and may comprise Ti/Au, Cr/Au, Ni/Au, Cu, Ag, or TCO-metal stacks. Bond pad lateral dimensions may be 30-300 micrometers. Bond pad lateral dimensions may be 50-150 micrometers. Bond pad thickness may be 100 nanometers to 10 micrometers.

An optional adhesion layer disposed between the substrate and the transparent conductive coating enhances interfacial robustness. In aspects, suitable adhesion layers can include titanium, chromium, tantalum, silicon oxide, or silane primers. The adhesion layer thickness may be 2-50 nanometers. The adhesion layer thickness may be 5-20 nanometers. Patterning to define islands 120 and gaps 110 may be accomplished by photolithography with wet or dry etching, laser ablation, direct-write printing with lift-off, or other subtractive or additive microfabrication techniques. Transitions between patterned regions may be pixelated or gradient to avoid straight boundaries and reduce spatial-frequency artifacts.

Optical and electrical performance of the patterned stack is configured to preserve see-through transparency and low conspicuity in a wearer's field of view. The average visible transmission may be at least 90% over 400-750 nanometers. The average visible transmission may be at least 95% over 400-750 nanometers. The haze may be at most 5%. The haze may be below 1%. The sheet resistance of the transparent conductive coating may be 3-30 ohms per square. The sheet resistance may be 5-15 ohms per square. The sheet resistance may be less than 8 ohms per square.

In operation, conductive islands 120 may be electrically coupled to components operating with direct current or low-frequency pulsed current. The pulsed current frequency may be less than 30 hertz. The pulsed current frequency may be less than 10 hertz. Off-lens electrical connections may be provided by edge terminals, flexible printed circuits, or embedded conductors along a frame region, while insulating gaps 110 maintain isolation across the in-field patterned area.

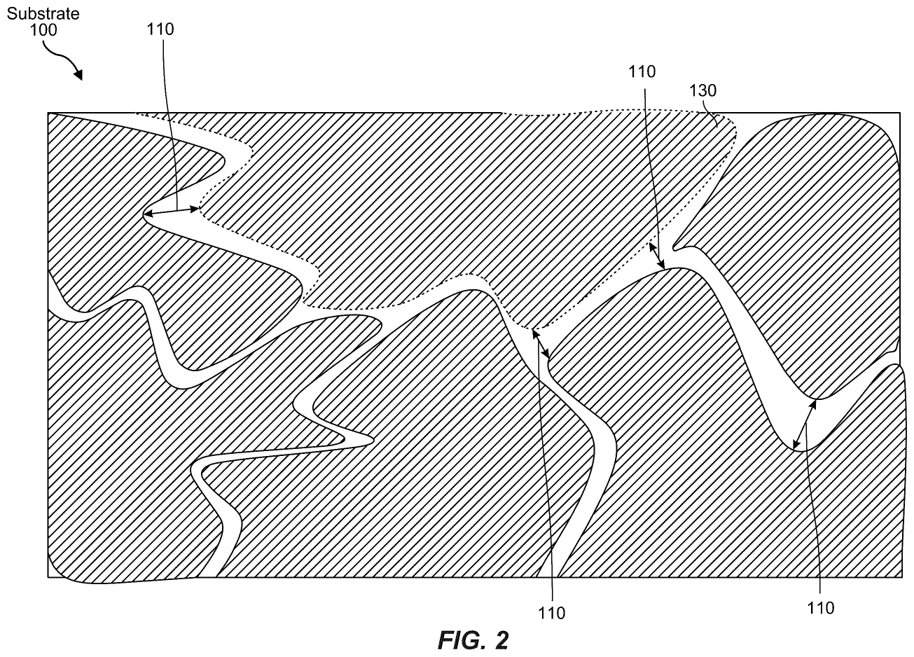

FIG. 2 illustrates a portion of an ophthalmic lens assembly in which a transparent ophthalmic substrate 100 supports a transparent conductive coating patterned to define the surface area 130 of a conductive island 120, with adjacent insulating gaps 110 providing electrical isolation.

Surface area 130 denotes the two-dimensional extent of an electrically continuous region of the transparent conductive coating configured as an electrode or interconnect. The conductive island 120 may be shaped in a free-form manner with boundaries that avoid long straight edges to reduce visual artifacts. A minimum local radius of curvature along the island boundary may exceed 2 micrometers. The minimum local radius of curvature may be 2-20 micrometers. The minimum local radius of curvature may be at least 5 micrometers. Bond pads may be positioned on the island to attach an electronic component and may comprise Ti/Au, Cr/Au, Ni/Au, Cu, Ag, or transparent-conductor/metal stacks compatible with flip-chip, wire bonding, anisotropic conductive film, or solder bump attachment. In some examples, bond pad lateral dimensions may be 30-300 micrometers. Bond pad lateral dimensions may be 50-150 micrometers. Bond pad thickness may be 100 nanometers to 10 micrometers.

An adhesion layer between the substrate and the coating may be used, including titanium, chromium, tantalum, silicon oxide, or silane primers. The adhesion layer thickness may be 2-50 nanometers. The adhesion layer thickness may be 5-20 nanometers. Patterning may be performed by photolithography with wet or dry etching, laser ablation, or direct-write printing with lift-off, and transitions may be pixelated or gradient to avoid straight boundaries.

Optical and electrical performance may preserve see-through transparency and low conspicuity. The average visible transmission may be at least 90% over 400-750 nanometers. The average visible transmission may be at least 95% over 400-750 nanometers. The haze may be at most 5%. The haze may be below 1%. The sheet resistance of the transparent conductive coating may be 3-30 ohms per square. The sheet resistance may be 5-15 ohms per square. The sheet resistance may be less than 8 ohms per square.

In operation, the island defined by surface area 130 may couple to components operating with direct current or low-frequency pulsed current. In some examples, the pulsed current frequency may be less than 30 hertz. The pulsed current frequency may also be less than 10 hertz. Off-lens electrical connections may be provided by edge terminals, flexible printed circuits, or embedded conductors along a frame region.

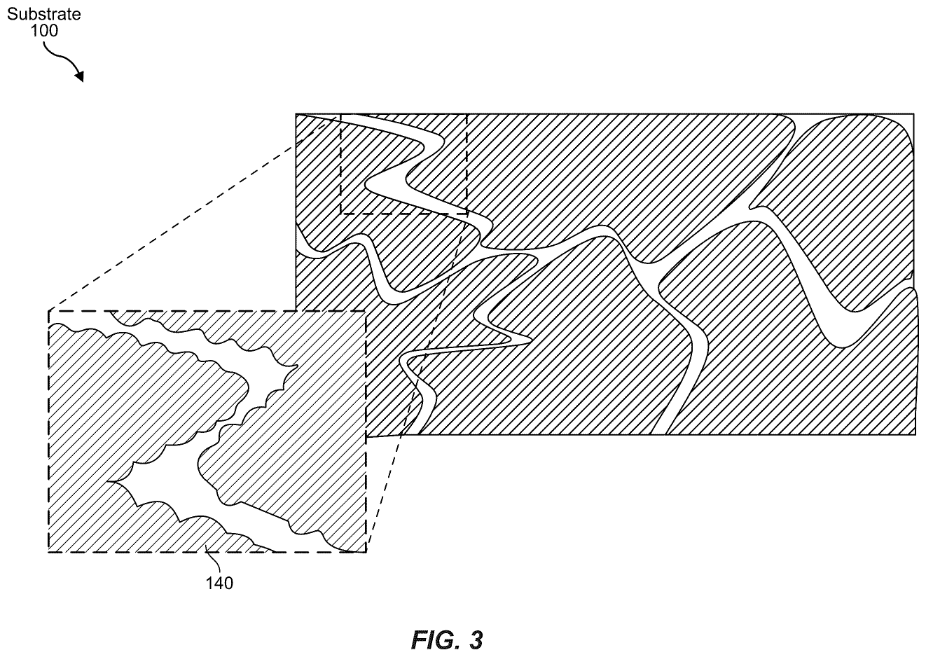

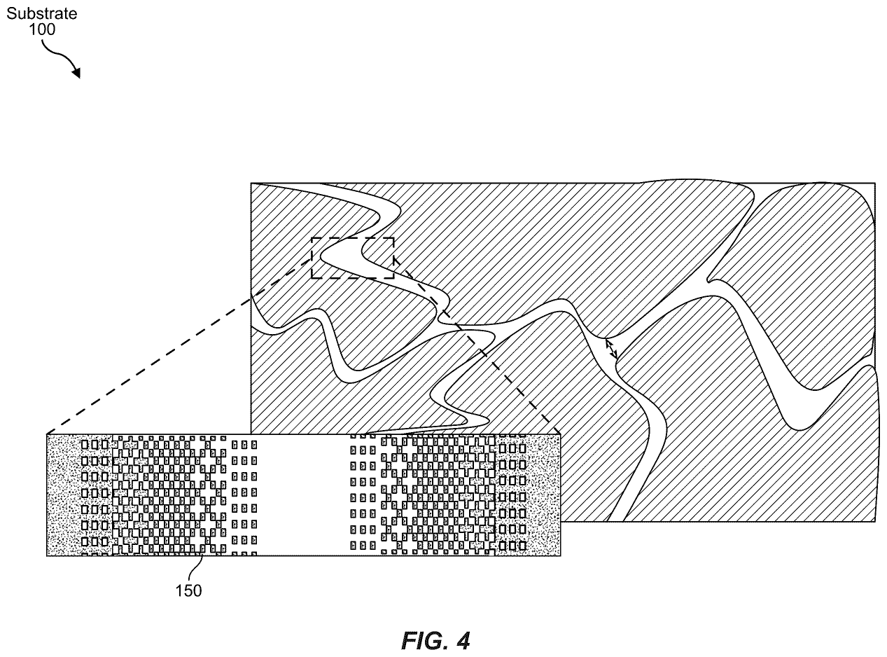

FIGS. 3 and 4 respectively illustrate alternative boundary treatments for conductive islands 120 and insulating gaps 110 formed on a transparent ophthalmic substrate 100, each configured to reduce straight-edge artifacts and visual conspicuity while preserving electrical isolation.

In FIG. 3, the boundaries of adjacent regions incorporate micro-wiggles 140 along the interface between a conductive island 120 and an insulating gap 110. As used herein, micro-wiggles are small-amplitude, non-linear perturbations of a boundary that break long straight segments to diffuse edge contrast and spatial-frequency content in the wearer's field of view. The wiggle amplitude may be 0.5-10 micrometers. The wiggle amplitude may be 1-5 micrometers. The wiggle spatial period may be 2-100 micrometers. The wiggle spatial period may be 5-50 micrometers. The local radius of curvature along the wiggled boundary may exceed 2 micrometers. The local radius of curvature may be 2-20 micrometers. The insulating gap minimum width adjacent to the wiggled boundary may be 20-100 micrometers. The insulating gap minimum width may be 35-50 micrometers. The total gap area relative to the corresponding island area may be less than 5%. The total gap area may be less than 2%.

In FIG. 4, the boundaries employ obfuscated edges 150 realized as pixelated or gradient transitions between a conductive island 120 and an insulating gap 110. As used herein, obfuscated edges are boundary regions in which discrete openings or pixels vary in size and density to create a graded transition that avoids a sharp, high-contrast edge. Pixel features may be square, circular, hexagonal, or irregular apertures formed in the conductive coating. The pixel pitch may be 2-200 micrometers. The pixel pitch may be 5-50 micrometers. The local duty cycle of conductive material across the transition may vary from 90% to 0%. The local duty cycle may vary over a transition length of 50-2000 micrometers. The transition length may be 100-500 micrometers. The insulating gap minimum width at the fully clear boundary may be 20-100 micrometers. The insulating gap minimum width may be 35-50 micrometers.

Either approach may be implemented with any transparent conductive coating described herein, including indium tin oxide (ITO), indium zinc oxide (IZO), aluminum-doped zinc oxide (AZO), fluorine-doped tin oxide (FTO), metal-nanowire networks, graphene, carbon-nanotube meshes, conductive polymers, ultrathin metallic grids, or hybrid stacks. Insulating gaps may be voids or may be filled with index-matching dielectric materials such as UV-curable acrylates, silicones, sol-gel oxides, or urethane acrylates. A fill layer thickness may be 0.5-10 micrometers. A fill layer thickness may be 1-5 micrometers.

Manufacture of the micro-wiggled boundary may use stochastic or sinusoidal edge modulation in a photolithographic mask, direct-write laser patterning, electron-beam lithography, or inkjet deposition followed by lift-off. Manufacture of the obfuscated edge may use halftone photomasks, gray-scale lithography, laser-written dot matrices, or printed micro-perforation patterns, followed by wet or dry etching. Etch depths for perforations may be 50-500 nanometers. Etch depths may be 100-300 nanometers. An adhesion layer such as titanium, chromium, tantalum, silicon oxide, or silane primer may be included beneath the conductive coating.

Other examples of boundary treatments include sinusoidal dithering, Voronoi-tessellated edges, randomized serrations with tapered tips, fractal or multi-scale perturbations, and tapered porous nanostructures that gradually reduce effective refractive index at the edge. The perturbation amplitude for such treatments may be 0.5-20 micrometers. The perturbation spatial period may be 2-200 micrometers. In these examples, the resulting conductive islands 120 remain electrically isolated from adjacent conductive material by insulating gaps 110 while the boundary treatment reduces visual conspicuity and edge artifacts.

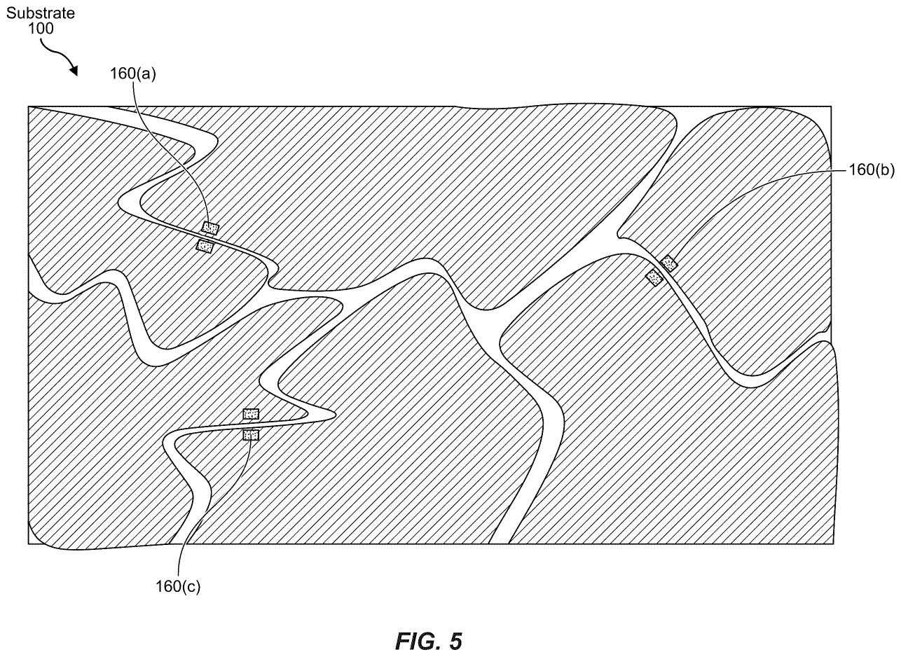

FIG. 5 depicts the surface area 130 of a conductive island 120 patterned on a transparent ophthalmic substrate 100, with adjacent insulating gaps 110 of variable width providing electrical isolation. Surface area 130 represents the electrically continuous region configured as an electrode or interconnect and bounded by a non-geometrically defined edge to reduce visual conspicuity. A minimum local radius of curvature along the boundary may exceed 2 micrometers. The minimum local radius of curvature may be 2-20 micrometers. The minimum local radius of curvature may be at least 5 micrometers. The insulating gaps 110 may have a minimum width of 20-100 micrometers. The insulating gaps 110 may have a minimum width of 35-50 micrometers. A total area of gaps relative to a corresponding island may be less than 5%. The total gap area may be less than 2%. The total gap area may be less than 1%. Conductive contacts 160(a), 160(b), and 160(c) on the island may be bond pads, vias, or metallized features for coupling to an electronic component or off-lens trace. Bond pad lateral dimensions may be 30-300 micrometers. Bond pad lateral dimensions may be 50-150 micrometers. Bond pad thickness may be 100 nanometers to 10 micrometers.

Optical and electrical performance for layout illustrated in FIG. 5 may preserve see-through transparency and low conspicuity while providing low-resistance interconnects. The average visible transmission may be at least 90% over 400-750 nanometers. The average visible transmission may be at least 95% over 400-750 nanometers. The haze may be at most 5%. The haze may be below 1%. The sheet resistance of the transparent conductive coating may be 3-30 ohms per square. The sheet resistance may be 5-15 ohms per square. The sheet resistance may be less than 8 ohms per square.

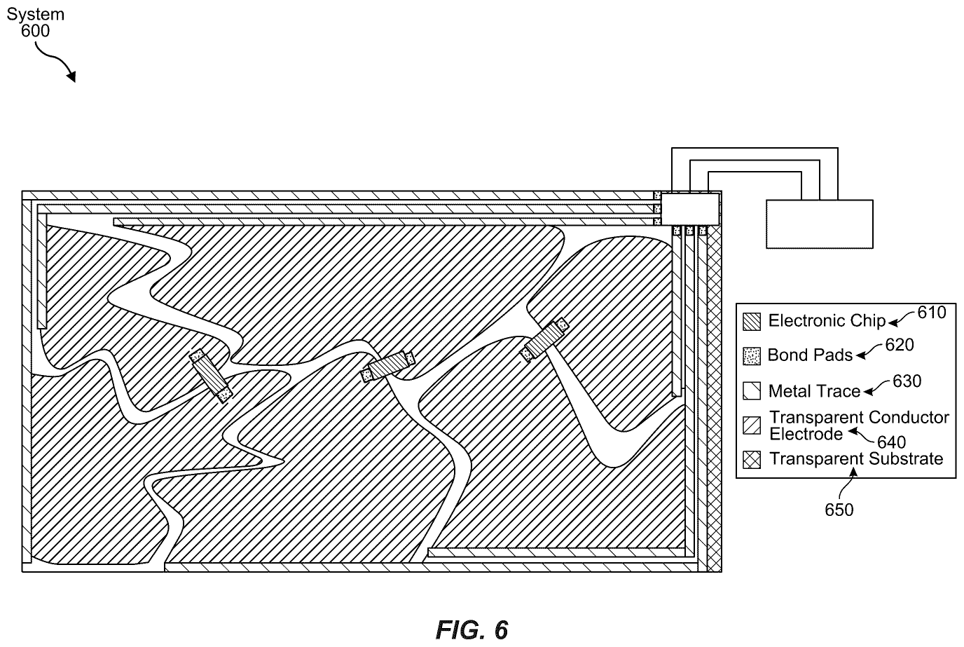

FIG. 6 illustrates a system 600 in which a transparent ophthalmic substrate 650 carries a transparent conductor electrode 640 patterned into free-form islands and interconnected to an off-lens chip driver via peripheral metal traces 630 and a flexible connector (flex). An “electronic chip” 610 is mounted within the patterned region and is electrically coupled through bond pads 620 aligned to corresponding metallized features on the islands and traces. The electronic chip may be a photosensor, detector, LED indicator, heater, or antenna element configured for direct current or low-frequency pulsed operation. The pulsed current frequency may be less than 30 hertz. The pulsed current frequency may be less than 10 hertz.

Bond pads 620 denote localized conductive areas on the lens-side metallization and on the electronic chip that align for attachment. Bond-pad stacks may include Ti/Au, Cr/Au, Ni/Au, Cu, Ag, or transparent conductor-metal combinations, and are compatible with flip-chip, wire bonding, solder bumps, or anisotropic conductive film. Bond pad lateral dimensions may be 30-300 micrometers. Bond pad lateral dimensions may be 50-150 micrometers. Bond pad thickness may be 100 nanometers to 10 micrometers.

Metal traces 630 provide low-resistance routing at the lens periphery and around the in-field islands to reach the flex or edge terminals while minimizing visual impact in the wearer's field of view. Suitable metals include copper, gold, silver, aluminum, nickel, or multilayer stacks with diffusion barriers (e.g., TiW, Cr). Metal trace thickness may be 100 nanometers to 10 micrometers. Metal trace thickness may be 0.5-5 micrometers. Where the transparent conductor carries current, resistance may be estimated by:

$$R = {R}_{s} \times ( L / W )$$

with sheet resistance Rₛ selected to maintain optical transparency and electrical performance.

The transparent conductor electrode 640 denotes the patterned portion of the transparent conductive coating that functions as an electrode or interconnect in the lens interior. Materials may include ITO, IZO, AZO, FTO, metal-nanowire networks, graphene, carbon-nanotube meshes, conductive polymers (PEDOT:PSS), ultrathin metallic grids, or hybrids. The coating thickness may be 50-300 nanometers. The coating thickness may be 100-150 nanometers. The coating thickness may be less than 200 nanometers. The sheet resistance may be 3-30 ohms per square. The sheet resistance may be 5-15 ohms per square. The sheet resistance may be less than 8 ohms per square.

The transparent ophthalmic substrate 650 supports all layers and may be glass, polycarbonate, cyclic olefin polymer or copolymer, acrylic, or polyurethane. The substrate thickness may be 200-800 micrometers. The substrate thickness may be 300-600 micrometers. The substrate thickness may be less than 500 micrometers. Peripheral “edge metal contacts” may be included to terminate traces for connection to the flex and off-lens driver without encroaching on the central vision zone.

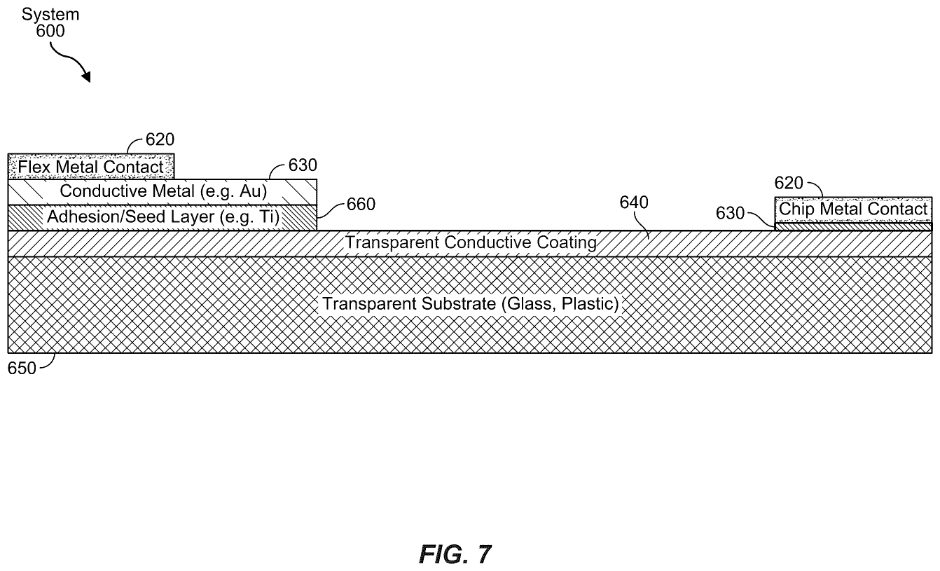

FIG. 7 is a cross-sectional schematic of system 600 showing the layer stack that couples the flex and chip to the transparent conductor. From top to bottom: bond pads 620; metal traces 630; an adhesion layer/seed layer 660; the transparent conductive coating forming electrode 640; and the transparent substrate 650. The adhesion layer 660 promotes interfacial robustness and seed deposition for subsequent metallization. Suitable adhesion/seed materials include titanium, chromium, tantalum, silicon oxide, or silane primers, optionally with sputtered Ti or Cr under Au/Cu. The adhesion layer thickness may be 2-50 nanometers. The adhesion layer thickness may be 5-20 nanometers.

The stack may include optional dielectric fills in insulating gaps to index-match the substrate and reduce edge contrast where the transparent conductor is removed. A fill layer thickness may be 0.5-10 micrometers. A fill layer thickness may be 1-5 micrometers. Transitions between transparent conductor regions and clear areas may be pixelated or gradient to avoid straight boundaries and reduce spatial-frequency artifacts, enabling low conspicuity for both wearer and outside observers.

The assembly may be configured so that the in-field pattern maintains see-through performance while supporting electrical attachment and peripheral routing to the off-lens driver. The average visible transmission may be at least 90% over 400-750 nanometers. The average visible transmission may be at least 95% over 400-750 nanometers. The haze may be at most 5%. The haze may be below 1%. Integration may be achieved by metal-to-metal flip-chip bonding between chip pads and lens bond pads, with underfill or encapsulant to enhance mechanical reliability without degrading optical clarity in adjacent transparent areas.

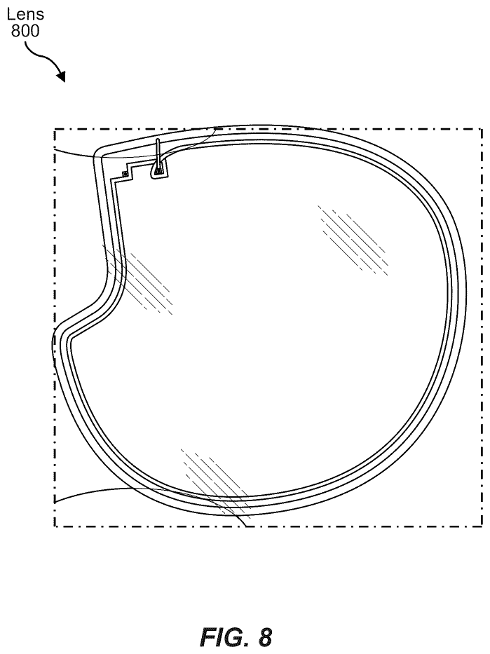

FIG. 8 is a diagram of a lens 800 exemplifying a transparent ophthalmic substrate with on-lens transparent circuitry implemented so that the central vision zone remains see-through while routing is placed predominantly at the periphery. The depicted lens shows peripheral metal trace regions terminating at edge contacts configured to mate with a flexible connector, with one or more bond-pad sites positioned near the upper perimeter for flip-chip attachment of an electronic component. The bond pads may be aligned to conductive islands formed from the transparent conductive coating and may be finished with underfill or an encapsulant to enhance mechanical reliability without introducing visible artifacts in adjacent clear areas. Insulating gaps between islands maintain electrical isolation across the in-field region and may be sized locally to meet bonding and crosstalk requirements while preserving low outside-viewer conspicuity.

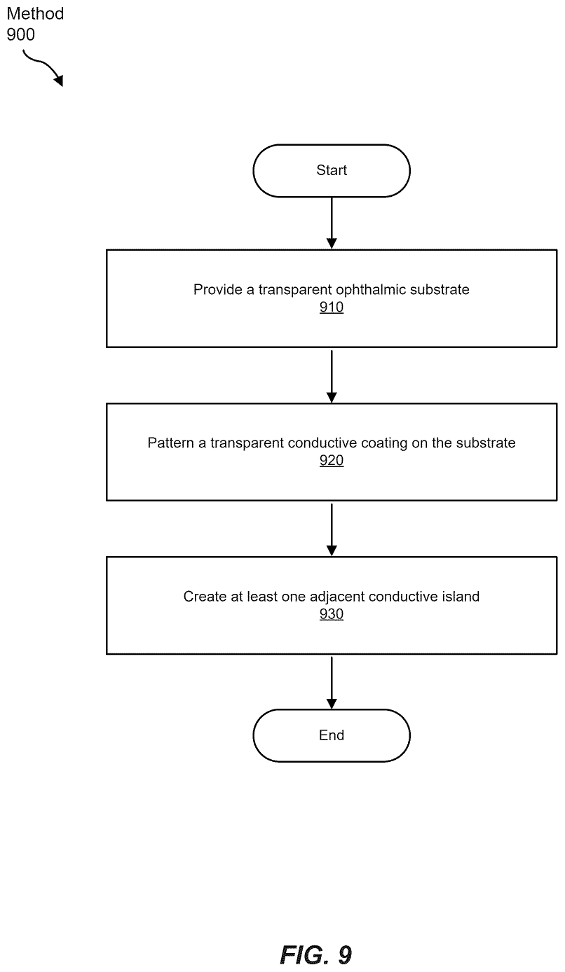

FIG. 9 shows a method 900 of manufacturing a substrate according to embodiments of this disclosure. The method may begin by providing a transparent ophthalmic substrate (step 910), such as a pre-cut or molded lens, a wafer-like lens blank, or a laminated lens stack prepared for near-eye use. The substrate may be cleaned, surface-activated, or primed to improve film adhesion, for example using oxygen plasma, UV-ozone, or silane primers, and fiducials may be added at the periphery to register masks and component placement. In some implementations, the substrate is temporarily bonded to a carrier to control flatness during processing and later released by a dissolvable adhesive or thermal debond.

A transparent conductive coating is then patterned on the substrate (step 920). The coating may be deposited blanket and subsequently patterned, or it may be directly written. Suitable flows include photolithography followed by wet or dry etch, laser ablation with scanned stochastic edge modulation, or printed resist with lift-off to yield non-geometric island boundaries; masks may employ halftone pixels or grayscale to realize gradient transitions. In variants, a seed or adhesion layer (e.g., Ti or Cr) is first laid down, followed by the transparent conductor, and the stack co-patterned; alternatively, selective area deposition (e.g., inkjet or aerosol jet) defines islands without global etch.

At least one adjacent conductive island is created so that an insulating gap remains between conductive regions (step 930). The second and subsequent islands are formed with local minimum spacing engineered for electrical isolation and bond-pad placement. The gap may remain a void or be filled post-pattern with an index-matching dielectric dispensed by spin, spray, inkjet, or micro-dispense and then cured thermally or by UV. Gap geometry may employ micro-wiggles, dithering, or pixelated transitions to reduce straight-edge visibility while meeting minimum gap width targets at pad sites. Alternatives include trenching into the substrate to increase isolation margin, or forming a thin non-conductive overcoat across gaps to suppress surface leakage. After gap formation, metallized bond pads can be added at minimum-spacing locations by sputter and lift-off or by electroplating on seed regions, and a low-profile underfill may be applied around bonded components to enhance mechanical robustness without encroaching into clear areas.

The foregoing description illustrates transparent, low-conspicuity circuitry integrated on ophthalmic lenses using non-geometrically defined conductive islands separated by insulating gaps, together with manufacturable layouts, materials, and attachment schemes that preserve see-through optical performance while enabling on-lens electronic functionality. Although specific embodiments, examples, and parameter ranges have been provided to convey workable implementations, these are merely illustrative and not limiting. Variations in substrate compositions, transparent conductor stacks, boundary treatments, gap fills, bond pad constructions, and fabrication sequences may be employed without departing from the scope of the appended claims. All such modifications, equivalents, and alternatives are intended to fall within the spirit of this disclosure.

Features from any of the embodiments described herein may be used in combination with one another in accordance with the general principles described herein. These and other embodiments, features, and advantages will be more fully understood upon reading the following detailed description in conjunction with the accompanying drawings and claims.

### EXAMPLE EMBODIMENTS

Clause 1. An ophthalmic lens assembly comprising: a transparent ophthalmic substrate; and a transparent conductive coating on the substrate, wherein: the transparent conductive coating is patterned into at least one conductive island that: is configured as an electrode; comprises a non-geometrically defined shape; and is separated from adjacent conductive material by an insulating gap.

Clause 2. The ophthalmic lens assembly of clause 1, wherein the transparent ophthalmic substrate comprises a planar lens formed of at least one of glass or polycarbonate.

Clause 3. The ophthalmic lens assembly of clause 1, wherein the transparent ophthalmic substrate provides an average visible transmission of at least 90% for light with wavelengths between 400 and 750 nanometers.

Clause 4. The ophthalmic lens assembly of clause 1, wherein the transparent ophthalmic substrate comprises a thickness less than 500 micrometers.

Clause 5. The ophthalmic lens assembly of clause 4, wherein the transparent conductive coating has a thickness between approximate 100 nanometers and 150 nanometers.

Clause 6. The ophthalmic lens assembly of clause 1, wherein the transparent conductive coating has a sheet resistance less than 15 ohms per square.

Clause 7. The ophthalmic lens assembly of clause 1, wherein the insulating gap comprises variable-width spacing between the adjacent conductive material.

Clause 8. The ophthalmic lens assembly of clause 1, wherein each curve of the at least one conductive island comprises a minimum radius of curvature greater than 2 micrometers along a boundary of the conductive island.

Clause 9. The ophthalmic lens assembly of clause 1, wherein a total area of the insulating gap between adjacent conductive islands is less than 5% of an area of a corresponding conductive island.

Clause 10. The ophthalmic lens assembly of clause 1, further comprising at least one electronic component electrically coupled to the at least one conductive island.

Clause 11. The ophthalmic lens assembly of clause 10, wherein the at least one electronic component is configured to operate with at least one of: direct current, or pulsed current having a frequency less than 10 Hz.

Clause 12. The ophthalmic lens assembly of clause 11, wherein the at least one electronic component is bonded to the at least one conductive island by metal-to-metal flip-chip bonding between respective metal bond pads.

Clause 13. The ophthalmic lens assembly of clause 1, further comprising an adhesive layer between the transparent ophthalmic substrate and the transparent conductive coating, the adhesive layer comprising titanium.

Clause 14. A method of manufacturing an ophthalmic lens assembly comprising: providing a transparent ophthalmic substrate; patterning a transparent conductive coating on the substrate in a manner that defines at least one conductive island configured as an electrode, the at least one conductive island comprising a non-geometrically defined shape; and creating at least one adjacent conductive island in a manner that leaves an insulating gap between conductive regions.

Clause 15. The method of clause 14, further comprising depositing an adhesive layer comprising titanium between the transparent ophthalmic substrate and the transparent conductive coating prior to patterning.

Clause 16. The method of clause 14, wherein patterning defines a boundary of each conductive island with a minimum local radius of curvature greater than 2 micrometers and creating leaves variable-width insulating gaps whose total area is less than 5% of a corresponding island area.

Clause 17. The method of clause 14, further comprising filling the insulating gap with an index-matching material, wherein the transparent conductive coating comprises a thickness between approximately 100 and 150 nanometers and achieves a sheet resistance less than 15 ohms per square.

Clause 18. An eyewear device comprising: a frame supporting; at least one ophthalmic lens assembly comprising: a transparent ophthalmic substrate, and a transparent conductive coating on the substrate, the transparent conductive coating patterned into at least one conductive island configured as an electrode, the at least one conductive island having a non-geometrically defined shape and being separated from adjacent conductive material by an insulating gap in a manner that provides electrical isolation while maintaining see-through transparency in a wearer's field of view.

Clause 19. The eyewear device of clause 18, wherein boundaries of the at least one conductive island have a minimum local radius of curvature greater than 2 micrometers and the insulating gap has variable width with a total area less than 5% of an area of a corresponding conductive island.

Clause 20. The eyewear device of clause 18, wherein: the insulating gap is filled with an index-matching material; the transparent conductive coating has a thickness between approximately 100 and 150 nanometers with a sheet resistance less than 15 ohms per square; and further comprising at least one electronic component that is flip-chip bonded to the at least one conductive island via metal bond pads.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

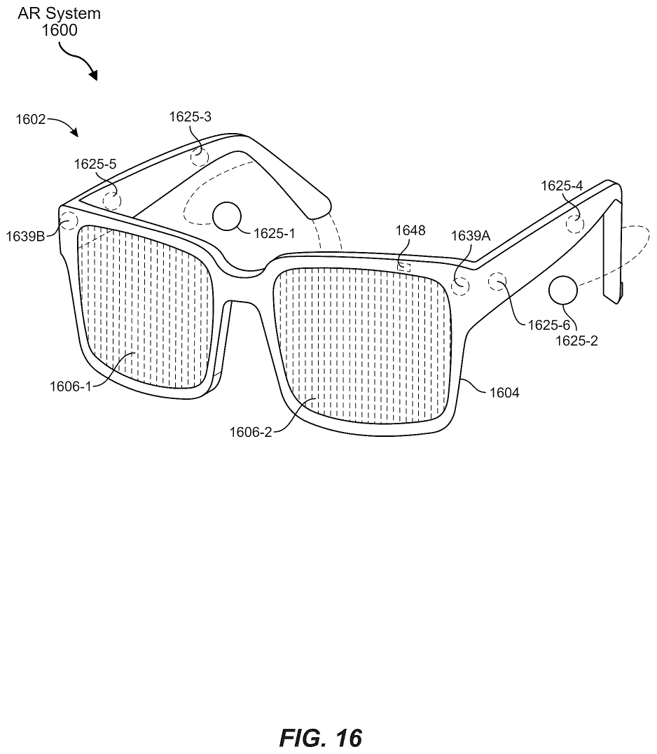

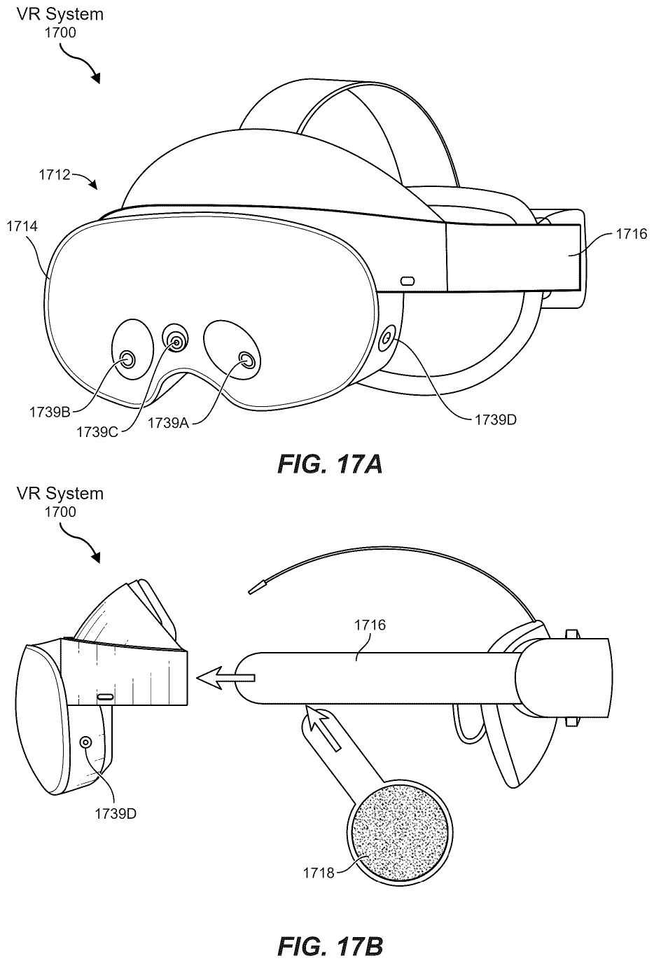

AR systems may be implemented in a variety of different form factors and configurations. Some AR systems may be designed to work without near-eye displays (NEDs). Other AR systems may include a NED that also provides visibility into the real world (such as, e.g., augmented-reality system 1600 in FIG. 16) or that visually immerses a user in an artificial reality (such as, e.g., virtual-reality system 1700 in FIGS. 17A and 17B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

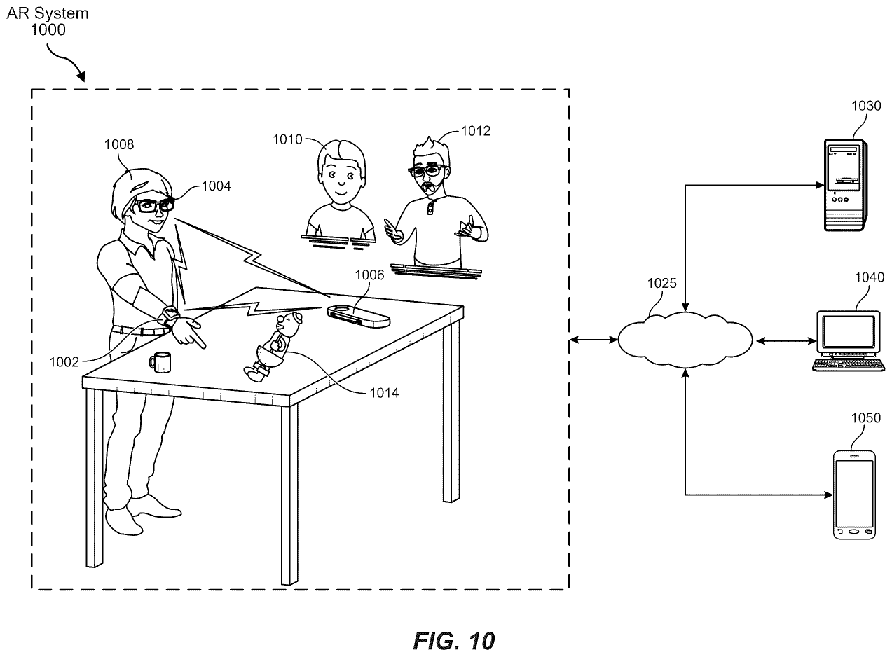

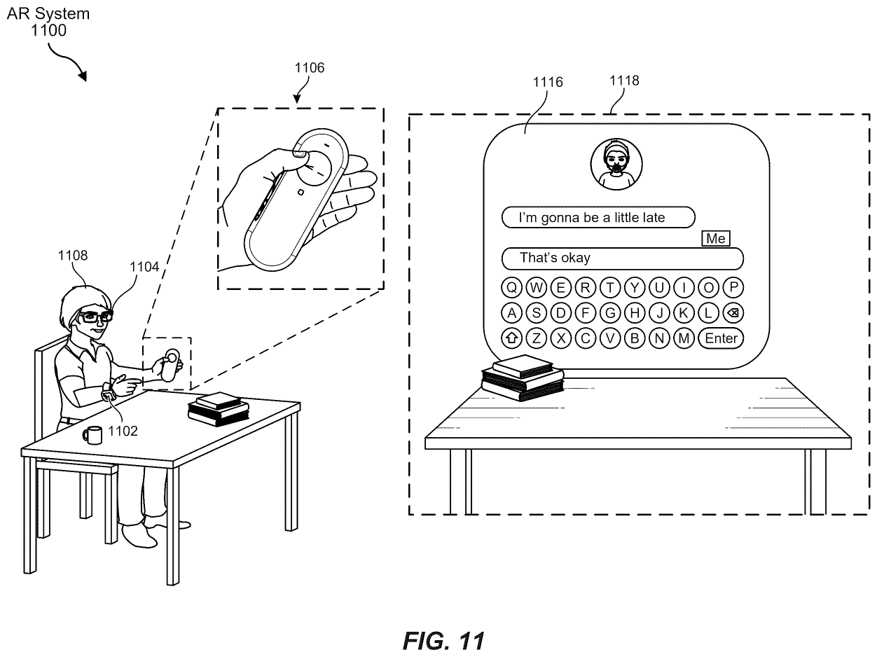

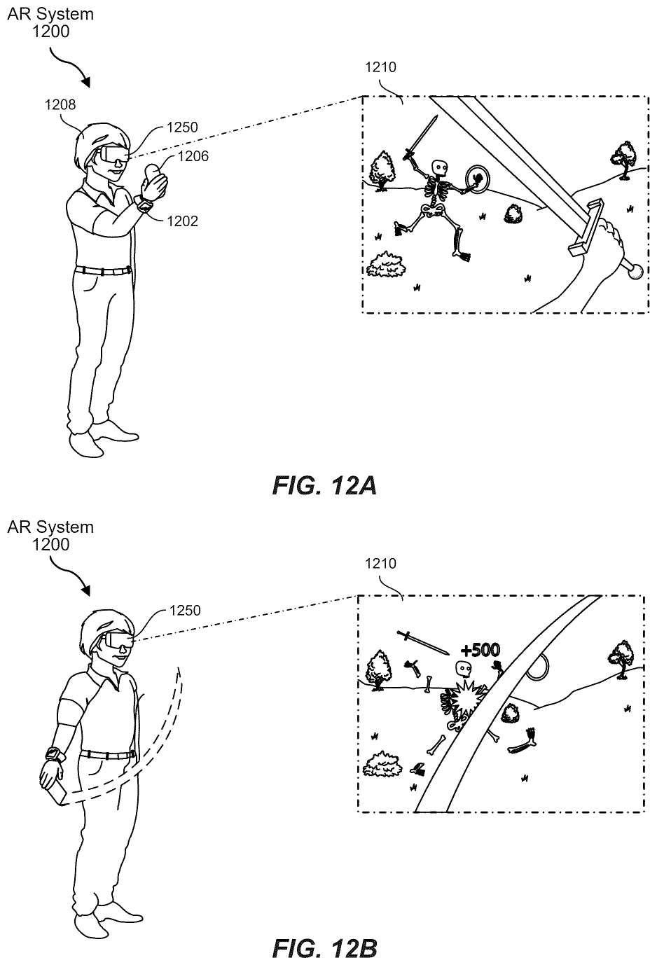

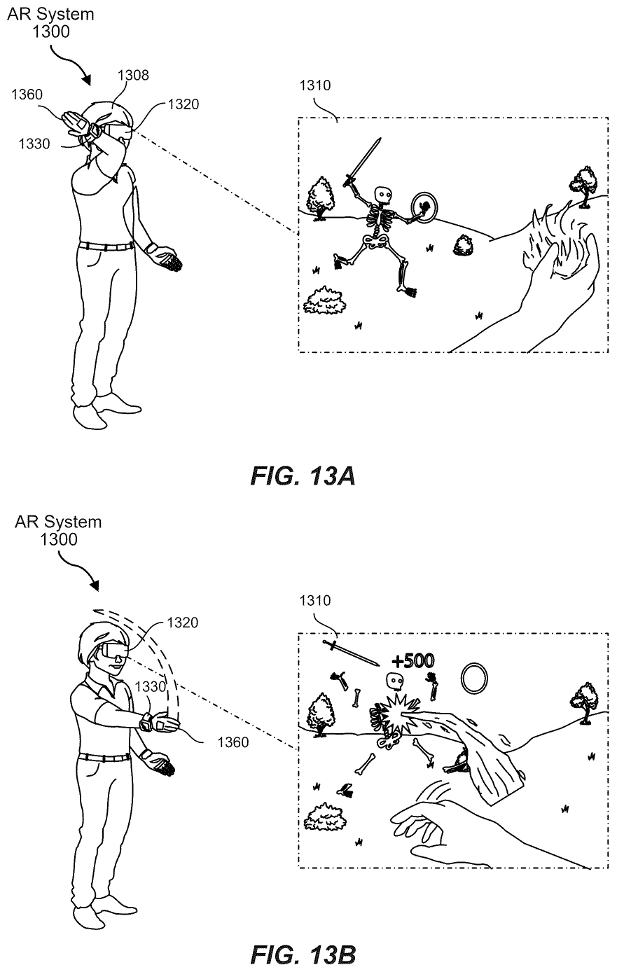

FIGS. 10-13B illustrate example artificial-reality (AR) systems in accordance with some embodiments. FIG. 10 shows a first AR system 1000 and first example user interactions using a wrist-wearable device 1002, a head-wearable device (e.g., AR system 1600), and/or a handheld intermediary processing device (HIPD) 1006. FIG. 11 shows a second AR system 1100 and second example user interactions using a wrist-wearable device 1102, AR glasses 1104, and/or an HIPD 1106. FIGS. 12A and 12B show a third AR system 1200 and third example user 1208 interactions using a wrist-wearable device 1202, a head-wearable device (e.g., VR headset 1250), and/or an HIPD 1206. FIGS. 13A and 13B show a fourth AR system 1300 and fourth example user 1308 interactions using a wrist-wearable device 1330, VR headset 1320, and/or a haptic device 1360 (e.g., wearable gloves).

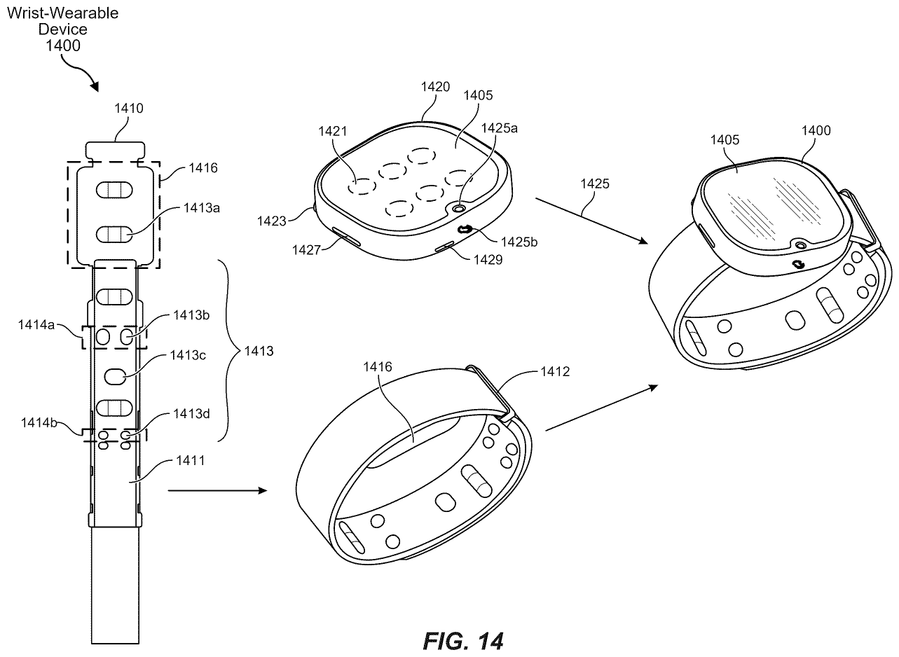

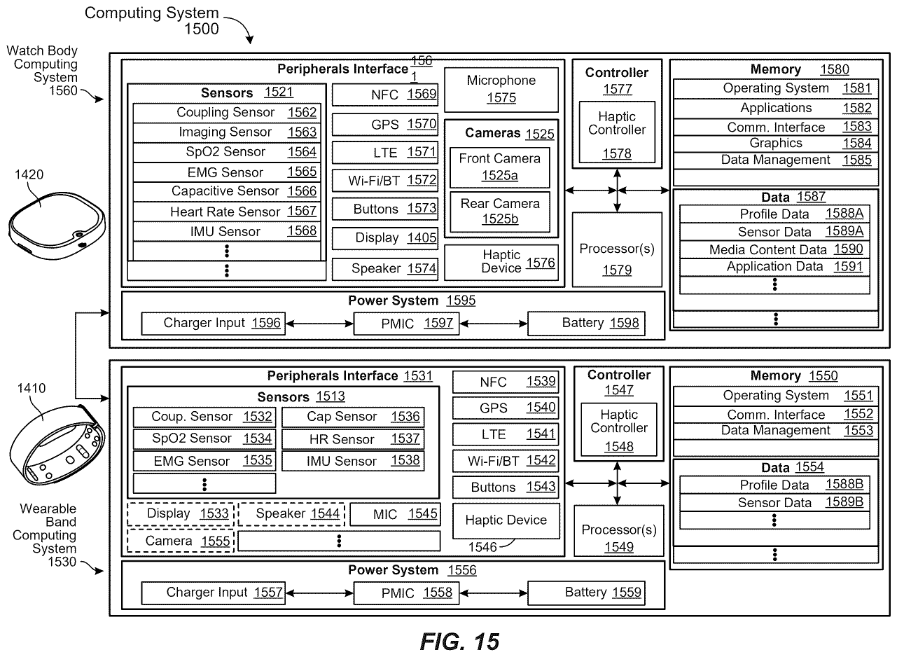

A wrist-wearable device 1400, which can be used for wrist-wearable device 1002, 1102, 1202, 1330, and one or more of its components, are described below in reference to FIGS. 14 and 15; head-wearable devices (e.g., AR system 1600 and virtual-reality system 1700), which can respectively be used for AR glasses 1004, 1104 or VR headset 1250, 1320, and their one or more components are described below in reference to FIGS. 16-18.

Referring to FIG. 10, wrist-wearable device 1002, AR glasses 1004, and/or HIPD 1006 can communicatively couple via a network 1025 (e.g., cellular, near field, Wi-Fi, personal area network, wireless LAN, etc.). Additionally, wrist-wearable device 1002, AR glasses 1004, and/or HIPD 1006 can also communicatively couple with one or more servers 1030, computers 1040 (e.g., laptops, computers, etc.), mobile devices 1050 (e.g., smartphones, tablets, etc.), and/or other electronic devices via network 1025 (e.g., cellular, near field, Wi-Fi, personal area network, wireless LAN, etc.).

In FIG. 10, a user 1008 is shown wearing wrist-wearable device 1002 and AR glasses 1004 and having HIPD 1006 on their desk. The wrist-wearable device 1002, AR glasses 1004, and HIPD 1006 facilitate user interaction with an AR environment. In particular, as shown by first AR system 1000, wrist-wearable device 1002, AR glasses 1004, and/or HIPD 1006 cause presentation of one or more avatars 1010, digital representations of contacts 1012, and virtual objects 1014. As discussed below, user 1008 can interact with one or more avatars 1010, digital representations of contacts 1012, and virtual objects 1014 via wrist-wearable device 1002, AR glasses 1004, and/or HIPD 1006.

User 1008 can use any of wrist-wearable device 1002, AR glasses 1004, and/or HIPD 1006 to provide user inputs. For example, user 1008 can perform one or more hand gestures that are detected by wrist-wearable device 1002 (e.g., using one or more EMG sensors and/or IMUs, described below in reference to FIGS. 14 and 15) and/or AR glasses 1004 (e.g., using one or more image sensor or camera, described below in reference to FIGS. 16-18) to provide a user input. Alternatively, or additionally, user 1008 can provide a user input via one or more touch surfaces of wrist-wearable device 1002, AR glasses 1004, HIPD 1006, and/or voice commands captured by a microphone of wrist-wearable device 1002, AR glasses 1004, and/or HIPD 1006. In some embodiments, wrist-wearable device 1002, AR glasses 1004, and/or HIPD 1006 include a digital assistant to help user 1008 in providing a user input (e.g., completing a sequence of operations, suggesting different operations or commands, providing reminders, confirming a command, etc.). In some embodiments, user 1008 can provide a user input via one or more facial gestures and/or facial expressions. For example, cameras of wrist-wearable device 1002, AR glasses 1004, and/or HIPD 1006 can track eyes of user 1008 for navigating a user interface.

Wrist-wearable device 1002, AR glasses 1004, and/or HIPD 1006 can operate alone or in conjunction to allow user 1008 to interact with the AR environment. In some embodiments, HIPD 1006 is configured to operate as a central hub or control center for the wrist-wearable device 1002, AR glasses 1004, and/or another communicatively coupled device. For example, user 1008 can provide an input to interact with the AR environment at any of wrist-wearable device 1002, AR glasses 1004, and/or HIPD 1006, and HIPD 1006 can identify one or more back-end and front-end tasks to cause the performance of the requested interaction and distribute instructions to cause the performance of the one or more back-end and front-end tasks at wrist-wearable device 1002, AR glasses 1004, and/or HIPD 1006. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). HIPD 1006 can perform the back-end tasks and provide wrist-wearable device 1002 and/or AR glasses 1004 operational data corresponding to the performed back-end tasks such that wrist-wearable device 1002 and/or AR glasses 1004 can perform the front-end tasks. In this way, HIPD 1006, which has more computational resources and greater thermal headroom than wrist-wearable device 1002 and/or AR glasses 1004, performs computationally intensive tasks and reduces the computer resource utilization and/or power usage of wrist-wearable device 1002 and/or AR glasses 1004.

In the example shown by first AR system 1000, HIPD 1006 identifies one or more back-end tasks and front-end tasks associated with a user request to initiate an AR video call with one or more other users (represented by avatar 1010 and the digital representation of contact 1012) and distributes instructions to cause the performance of the one or more back-end tasks and front-end tasks. In particular, HIPD 1006 performs back-end tasks for processing and/or rendering image data (and other data) associated with the AR video call and provides operational data associated with the performed back-end tasks to AR glasses 1004 such that the AR glasses 1004 perform front-end tasks for presenting the AR video call (e.g., presenting avatar 1010 and digital representation of contact 1012).

In some embodiments, HIPD 1006 can operate as a focal or anchor point for causing the presentation of information. This allows user 1008 to be generally aware of where information is presented. For example, as shown in first AR system 1000, avatar 1010 and the digital representation of contact 1012 are presented above HIPD 1006. In particular, HIPD 1006 and AR glasses 1004 operate in conjunction to determine a location for presenting avatar 1010 and the digital representation of contact 1012. In some embodiments, information can be presented a predetermined distance from HIPD 1006 (e.g., within 5 meters). For example, as shown in first AR system 1000, virtual object 1014 is presented on the desk some distance from HIPD 1006. Similar to the above example, HIPD 1006 and AR glasses 1004 can operate in conjunction to determine a location for presenting virtual object 1014. Alternatively, in some embodiments, presentation of information is not bound by HIPD 1006. More specifically, avatar 1010, digital representation of contact 1012, and virtual object 1014 do not have to be presented within a predetermined distance of HIPD 1006.

User inputs provided at wrist-wearable device 1002, AR glasses 1004, and/or HIPD 1006 are coordinated such that the user can use any device to initiate, continue, and/or complete an operation. For example, user 1008 can provide a user input to AR glasses 1004 to cause AR glasses 1004 to present virtual object 1014 and, while virtual object 1014 is presented by AR glasses 1004, user 1008 can provide one or more hand gestures via wrist-wearable device 1002 to interact and/or manipulate virtual object 1014.

FIG. 11 shows a user 1108 wearing a wrist-wearable device 1102 and AR glasses 1104, and holding an HIPD 1106. In second AR system 1100, the wrist-wearable device 1102, AR glasses 1104, and/or HIPD 1106 are used to receive and/or provide one or more messages to a contact of user 1108. In particular, wrist-wearable device 1102, AR glasses 1104, and/or HIPD 1106 detect and coordinate one or more user inputs to initiate a messaging application and prepare a response to a received message via the messaging application.

In some embodiments, user 1108 initiates, via a user input, an application on wrist-wearable device 1102, AR glasses 1104, and/or HIPD 1106 that causes the application to initiate on at least one device. For example, in second AR system 1100, user 1108 performs a hand gesture associated with a command for initiating a messaging application (represented by messaging user interface 1116), wrist-wearable device 1102 detects the hand gesture and, based on a determination that user 1108 is wearing AR glasses 1104, causes AR glasses 1104 to present a messaging user interface 1116 of the messaging application. AR glasses 1104 can present messaging user interface 1116 to user 1108 via its display (e.g., as shown by a field of view 1118 of user 1108). In some embodiments, the application is initiated and executed on the device (e.g., wrist-wearable device 1102, AR glasses 1104, and/or HIPD 1106) that detects the user input to initiate the application, and the device provides another device operational data to cause the presentation of the messaging application. For example, wrist-wearable device 1102 can detect the user input to initiate a messaging application, initiate and run the messaging application, and provide operational data to AR glasses 1104 and/or HIPD 1106 to cause presentation of the messaging application. Alternatively, the application can be initiated and executed at a device other than the device that detected the user input. For example, wrist-wearable device 1102 can detect the hand gesture associated with initiating the messaging application and cause HIPD 1106 to run the messaging application and coordinate the presentation of the messaging application.

Further, user 1108 can provide a user input provided at wrist-wearable device 1102, AR glasses 1104, and/or HIPD 1106 to continue and/or complete an operation initiated at another device. For example, after initiating the messaging application via wrist-wearable device 1102 and while AR glasses 1104 present messaging user interface 1116, user 1108 can provide an input at HIPD 1106 to prepare a response (e.g., shown by the swipe gesture performed on HIPD 1106). Gestures performed by user 1108 on HIPD 1106 can be provided and/or displayed on another device. For example, a swipe gestured performed on HIPD 1106 is displayed on a virtual keyboard of messaging user interface 1116 displayed by AR glasses 1104.

In some embodiments, wrist-wearable device 1102, AR glasses 1104, HIPD 1106, and/or any other communicatively coupled device can present one or more notifications to user 1108. The notification can be an indication of a new message, an incoming call, an application update, a status update, etc. User 1108 can select the notification via wrist-wearable device 1102, AR glasses 1104, and/or HIPD 1106 and can cause presentation of an application or operation associated with the notification on at least one device. For example, user 1108 can receive a notification that a message was received at wrist-wearable device 1102, AR glasses 1104, HIPD 1106, and/or any other communicatively coupled device and can then provide a user input at wrist-wearable device 1102, AR glasses 1104, and/or HIPD 1106 to review the notification, and the device detecting the user input can cause an application associated with the notification to be initiated and/or presented at wrist-wearable device 1102, AR glasses 1104, and/or HIPD 1106.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 1104 can present to user 1108 game application data, and HIPD 1106 can be used as a controller to provide inputs to the game. Similarly, user 1108 can use wrist-wearable device 1102 to initiate a camera of AR glasses 1104, and user 1108 can use wrist-wearable device 1102, AR glasses 1104, and/or HIPD 1106 to manipulate the image capture (e.g., zoom in or out, apply filters, etc.) and capture image data.

Users may interact with the devices disclosed herein in a variety of ways. For example, as shown in FIGS. 12A and 12B, a user 1208 may interact with an AR system 1200 by donning a VR headset 1250 while holding HIPD 1206 and wearing wrist-wearable device 1202. In this example, AR system 1200 may enable a user to interact with a game 1210 by swiping their arm. One or more of VR headset 1250, HIPD 1206, and wrist-wearable device 1202 may detect this gesture and, in response, may display a sword strike in game 1210. Similarly, in FIGS. 13A and 13B, a user 1308 may interact with an AR system 1300 by donning a VR headset 1320 while wearing haptic device 1360 and wrist-wearable device 1330. In this example, AR system 1300 may enable a user to interact with a game 1310 by swiping their arm. One or more of VR headset 1320, haptic device 1360, and wrist-wearable device 1330 may detect this gesture and, in response, may display a spell being cast in game 1210.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiogramar EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configured to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 1602.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 14 and 15 illustrate an example wrist-wearable device 1400 and an example computer system 1500, in accordance with some embodiments. Wrist-wearable device 1400 is an instance of wearable device 1002 described in FIG. 10 herein, such that the wearable device 1002 should be understood to have the features of the wrist-wearable device 1400 and vice versa. FIG. 15 illustrates components of the wrist-wearable device 1400, which can be used individually or in combination, including combinations that include other electronic devices and/or electronic components.

FIG. 14 shows a wearable band 1410 and a watch body 1420 (or capsule) being coupled, as discussed below, to form wrist-wearable device 1400. Wrist-wearable device 1400 can perform various functions and/or operations associated with navigating through user interfaces and selectively opening applications as well as the functions and/or operations described above with reference to FIGS. 10-13B.

As will be described in more detail below, operations executed by wrist-wearable device 1400 can include (i) presenting content to a user (e.g., displaying visual content via a display 1405), (ii) detecting (e.g., sensing) user input (e.g., sensing a touch on peripheral button 1423 and/or at a touch screen of the display 1405, a hand gesture detected by sensors (e.g., biopotential sensors)), (iii) sensing biometric data (e.g., neuromuscular signals, heart rate, temperature, sleep, etc.) via one or more sensors 1413, messaging (e.g., text, speech, video, etc.); image capture via one or more imaging devices or cameras 1425, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 1420, independently in wearable band 1410, and/or via an electronic communication between watch body 1420 and wearable band 1410. In some embodiments, functions can be executed on wrist-wearable device 1400 while an AR environment is being presented (e.g., via one of AR systems 1000 to 1300). The wearable devices described herein can also be used with other types of AR environments.

Wearable band 1410 can be configured to be worn by a user such that an inner surface of a wearable structure 1411 of wearable band 1410 is in contact with the user's skin. In this example, when worn by a user, sensors 1413 may contact the user's skin. In some examples, one or more of sensors 1413 can sense biometric data such as a user's heart rate, a saturated oxygen level, temperature, sweat level, neuromuscular signals, or a combination thereof. One or more of sensors 1413 can also sense data about a user's environment including a user's motion, altitude, location, orientation, gait, acceleration, position, or a combination thereof. In some embodiment, one or more of sensors 1413 can be configured to track a position and/or motion of wearable band 1410. One or more of sensors 1413 can include any of the sensors defined above and/or discussed below with respect to FIG. 14.

One or more of sensors 1413 can be distributed on an inside and/or an outside surface of wearable band 1410. In some embodiments, one or more of sensors 1413 are uniformly spaced along wearable band 1410. Alternatively, in some embodiments, one or more of sensors 1413 are positioned at distinct points along wearable band 1410. As shown in FIG. 14, one or more of sensors 1413 can be the same or distinct. For example, in some embodiments, one or more of sensors 1413 can be shaped as a pill (e.g., sensor 1413a), an oval, a circle a square, an oblong (e.g., sensor 1413c) and/or any other shape that maintains contact with the user's skin (e.g., such that neuromuscular signal and/or other biometric data can be accurately measured at the user's skin). In some embodiments, one or more sensors of 1413 are aligned to form pairs of sensors (e.g., for sensing neuromuscular signals based on differential sensing within each respective sensor). For example, sensor 1413b may be aligned with an adjacent sensor to form sensor pair 1414a and sensor 1413d may be aligned with an adjacent sensor to form sensor pair 1414b. In some embodiments, wearable band 1410 does not have a sensor pair. Alternatively, in some embodiments, wearable band 1410 has a predetermined number of sensor pairs (one pair of sensors, three pairs of sensors, four pairs of sensors, six pairs of sensors, sixteen pairs of sensors, etc.).

Wearable band 1410 can include any suitable number of sensors 1413. In some embodiments, the number and arrangement of sensors 1413 depends on the particular application for which wearable band 1410 is used. For instance, wearable band 1410 can be configured as an armband, wristband, or chest-band that include a plurality of sensors 1413 with different number of sensors 1413, a variety of types of individual sensors with the plurality of sensors 1413, and different arrangements for each use case, such as medical use cases as compared to gaming or general day-to-day use cases.

In accordance with some embodiments, wearable band 1410 further includes an electrical ground electrode and a shielding electrode. The electrical ground and shielding electrodes, like the sensors 1413, can be distributed on the inside surface of the wearable band 1410 such that they contact a portion of the user's skin. For example, the electrical ground and shielding electrodes can be at an inside surface of a coupling mechanism 1416 or an inside surface of a wearable structure 1411. The electrical ground and shielding electrodes can be formed and/or use the same components as sensors 1413. In some embodiments, wearable band 1410 includes more than one electrical ground electrode and more than one shielding electrode.

Sensors 1413 can be formed as part of wearable structure 1411 of wearable band 1410. In some embodiments, sensors 1413 are flush or substantially flush with wearable structure 1411 such that they do not extend beyond the surface of wearable structure 1411. While flush with wearable structure 1411, sensors 1413 are still configured to contact the user's skin (e.g., via a skin-contacting surface). Alternatively, in some embodiments, sensors 1413 extend beyond wearable structure 1411 a predetermined distance (e.g., 0.1-2 mm) to make contact and depress into the user's skin. In some embodiment, sensors 1413 are coupled to an actuator (not shown) configured to adjust an extension height (e.g., a distance from the surface of wearable structure 1411) of sensors 1413 such that sensors 1413 make contact and depress into the user's skin. In some embodiments, the actuators adjust the extension height between 0.01 mm-1.2 mm. This may allow a the user to customize the positioning of sensors 1413 to improve the overall comfort of the wearable band 1410 when worn while still allowing sensors 1413 to contact the user's skin. In some embodiments, sensors 1413 are indistinguishable from wearable structure 1411 when worn by the user.

Wearable structure 1411 can be formed of an elastic material, elastomers, etc., configured to be stretched and fitted to be worn by the user. In some embodiments, wearable structure 1411 is a textile or woven fabric. As described above, sensors 1413 can be formed as part of a wearable structure 1411. For example, sensors 1413 can be molded into the wearable structure 1411, be integrated into a woven fabric (e.g., sensors 1413 can be sewn into the fabric and mimic the pliability of fabric and can and/or be constructed from a series woven strands of fabric).

Wearable structure 1411 can include flexible electronic connectors that interconnect sensors 1413, the electronic circuitry, and/or other electronic components (described below in reference to FIG. 15) that are enclosed in wearable band 1410. In some embodiments, the flexible electronic connectors are configured to interconnect sensors 1413, the electronic circuitry, and/or other electronic components of wearable band 1410 with respective sensors and/or other electronic components of another electronic device (e.g., watch body 1420). The flexible electronic connectors are configured to move with wearable structure 1411 such that the user adjustment to wearable structure 1411 (e.g., resizing, pulling, folding, etc.) does not stress or strain the electrical coupling of components of wearable band 1410.

As described above, wearable band 1410 is configured to be worn by a user. In particular, wearable band 1410 can be shaped or otherwise manipulated to be worn by a user. For example, wearable band 1410 can be shaped to have a substantially circular shape such that it can be configured to be worn on the user's lower arm or wrist. Alternatively, wearable band 1410 can be shaped to be worn on another body part of the user, such as the user's upper arm (e.g., around a bicep), forearm, chest, legs, etc. Wearable band 1410 can include a retaining mechanism 1412 (e.g., a buckle, a hook and loop fastener, etc.) for securing wearable band 1410 to the user's wrist or other body part. While wearable band 1410 is worn by the user, sensors 1413 sense data (referred to as sensor data) from the user's skin. In some examples, sensors 1413 of wearable band 1410 obtain (e.g., sense and record) neuromuscular signals.

The sensed data (e.g., sensed neuromuscular signals) can be used to detect and/or determine the user's intention to perform certain motor actions. In some examples, sensors 1413 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 1405 of wrist-wearable device 1400 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 1413 can be used to provide a user with an enhanced interaction with a physical object (e.g., devices communicatively coupled with wearable band 1410) and/or a virtual object in an artificial-reality application generated by an artificial-reality system (e.g., user interface objects presented on the display 1405, or another computing device (e.g., a smartphone)).

In some embodiments, wearable band 1410 includes one or more haptic devices 1546 (e.g., a vibratory haptic actuator) that are configured to provide haptic feedback (e.g., a cutaneous and/or kinesthetic sensation, etc.) to the user's skin. Sensors 1413 and/or haptic devices 1546 (shown in FIG. 15) can be configured to operate in conjunction with multiple applications including, without limitation, health monitoring, social media, games, and artificial reality (e.g., the applications associated with artificial reality).

Wearable band 1410 can also include coupling mechanism 1416 for detachably coupling a capsule (e.g., a computing unit) or watch body 1420 (via a coupling surface of the watch body 1420) to wearable band 1410. For example, a cradle or a shape of coupling mechanism 1416 can correspond to shape of watch body 1420 of wrist-wearable device 1400. In particular, coupling mechanism 1416 can be configured to receive a coupling surface proximate to the bottom side of watch body 1420 (e.g., a side opposite to a front side of watch body 1420 where display 1405 is located), such that a user can push watch body 1420 downward into coupling mechanism 1416 to attach watch body 1420 to coupling mechanism 1416. In some embodiments, coupling mechanism 1416 can be configured to receive a top side of the watch body 1420 (e.g., a side proximate to the front side of watch body 1420 where display 1405 is located) that is pushed upward into the cradle, as opposed to being pushed downward into coupling mechanism 1416. In some embodiments, coupling mechanism 1416 is an integrated component of wearable band 1410 such that wearable band 1410 and coupling mechanism 1416 are a single unitary structure. In some embodiments, coupling mechanism 1416 is a type of frame or shell that allows watch body 1420 coupling surface to be retained within or on wearable band 1410 coupling mechanism 1416 (e.g., a cradle, a tracker band, a support base, a clasp, etc.).

Coupling mechanism 1416 can allow for watch body 1420 to be detachably coupled to the wearable band 1410 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1420 to wearable band 1410 and to decouple the watch body 1420 from the wearable band 1410. For example, a user can twist, slide, turn, push, pull, or rotate watch body 1420 relative to wearable band 1410, or a combination thereof, to attach watch body 1420 to wearable band 1410 and to detach watch body 1420 from wearable band 1410. Alternatively, as discussed below, in some embodiments, the watch body 1420 can be decoupled from the wearable band 1410 by actuation of a release mechanism 1429.

Wearable band 1410 can be coupled with watch body 1420 to increase the functionality of wearable band 1410 (e.g., converting wearable band 1410 into wrist-wearable device 1400, adding an additional computing unit and/or battery to increase computational resources and/or a battery life of wearable band 1410, adding additional sensors to improve sensed data, etc.). As described above, wearable band 1410 and coupling mechanism 1416 are configured to operate independently (e.g., execute functions independently) from watch body 1420. For example, coupling mechanism 1416 can include one or more sensors 1413 that contact a user's skin when wearable band 1410 is worn by the user, with or without watch body 1420 and can provide sensor data for determining control commands.

A user can detach watch body 1420 from wearable band 1410 to reduce the encumbrance of wrist-wearable device 1400 to the user. For embodiments in which watch body 1420 is removable, watch body 1420 can be referred to as a removable structure, such that in these embodiments wrist-wearable device 1400 includes a wearable portion (e.g., wearable band 1410) and a removable structure (e.g., watch body 1420).

Turning to watch body 1420, in some examples watch body 1420 can have a substantially rectangular or circular shape. Watch body 1420 is configured to be worn by the user on their wrist or on another body part. More specifically, watch body 1420 is sized to be easily carried by the user, attached on a portion of the user's clothing, and/or coupled to wearable band 1410 (forming the wrist-wearable device 1400). As described above, watch body 1420 can have a shape corresponding to coupling mechanism 1416 of wearable band 1410. In some embodiments, watch body 1420 includes a single release mechanism 1429 or multiple release mechanisms (e.g., two release mechanisms 1429 positioned on opposing sides of watch body 1420, such as spring-loaded buttons) for decoupling watch body 1420 from wearable band 1410. Release mechanism 1429 can include, without limitation, a button, a knob, a plunger, a handle, a lever, a fastener, a clasp, a dial, a latch, or a combination thereof.

A user can actuate release mechanism 1429 by pushing, turning, lifting, depressing, shifting, or performing other actions on release mechanism 1429. Actuation of release mechanism 1429 can release (e.g., decouple) watch body 1420 from coupling mechanism 1416 of wearable band 1410, allowing the user to use watch body 1420 independently from wearable band 1410 and vice versa. For example, decoupling watch body 1420 from wearable band 1410 can allow a user to capture images using rear-facing camera 1425b. Although release mechanism 1429 is shown positioned at a corner of watch body 1420, release mechanism 1429 can be positioned anywhere on watch body 1420 that is convenient for the user to actuate. In addition, in some embodiments, wearable band 1410 can also include a respective release mechanism for decoupling watch body 1420 from coupling mechanism 1416. In some embodiments, release mechanism 1429 is optional and watch body 1420 can be decoupled from coupling mechanism 1416 as described above (e.g., via twisting, rotating, etc.).

Watch body 1420 can include one or more peripheral buttons 1423 and 1427 for performing various operations at watch body 1420. For example, peripheral buttons 1423 and 1427 can be used to turn on or wake (e.g., transition from a sleep state to an active state) display 1405, unlock watch body 1420, increase or decrease a volume, increase or decrease a brightness, interact with one or more applications, interact with one or more user interfaces, etc. Additionally or alternatively, in some embodiments, display 1405 operates as a touch screen and allows the user to provide one or more inputs for interacting with watch body 1420.

In some embodiments, watch body 1420 includes one or more sensors 1421. Sensors 1421 of watch body 1420 can be the same or distinct from sensors 1413 of wearable band 1410. Sensors 1421 of watch body 1420 can be distributed on an inside and/or an outside surface of watch body 1420. In some embodiments, sensors 1421 are configured to contact a user's skin when watch body 1420 is worn by the user. For example, sensors 1421 can be placed on the bottom side of watch body 1420 and coupling mechanism 1416 can be a cradle with an opening that allows the bottom side of watch body 1420 to directly contact the user's skin.

Alternatively, in some embodiments, watch body 1420 does not include sensors that are configured to contact the user's skin (e.g., including sensors internal and/or external to the watch body 1420 that are configured to sense data of watch body 1420 and the surrounding environment). In some embodiments, sensors 1421 are configured to track a position and/or motion of watch body 1420.

Watch body 1420 and wearable band 1410 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 1420 and wearable band 1410 can share data sensed by sensors 1413 and 1421, as well as application and device specific information (e.g., active and/or available applications, output devices (e.g., displays, speakers, etc.), input devices (e.g., touch screens, microphones, imaging sensors, etc.).

In some embodiments, watch body 1420 can include, without limitation, a front-facing camera 1425a and/or a rear-facing camera 1425b, sensors 1421 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1563), a touch sensor, a sweat sensor, etc.). In some embodiments, watch body 1420 can include one or more haptic devices 1576 (e.g., a vibratory haptic actuator) that is configured to provide haptic feedback (e.g., a cutaneous and/or kinesthetic sensation, etc.) to the user. Sensors 1521 and/or haptic device 1576 can also be configured to operate in conjunction with multiple applications including, without limitation, health monitoring applications, social media applications, game applications, and artificial reality applications (e.g., the applications associated with artificial reality).

As described above, watch body 1420 and wearable band 1410, when coupled, can form wrist-wearable device 1400. When coupled, watch body 1420 and wearable band 1410 may operate as a single device to execute functions (operations, detections, communications, etc.) described herein. In some embodiments, each device may be provided with particular instructions for performing the one or more operations of wrist-wearable device 1400. For example, in accordance with a determination that watch body 1420 does not include neuromuscular signal sensors, wearable band 1410 can include alternative instructions for performing associated instructions (e.g., providing sensed neuromuscular signal data to watch body 1420 via a different electronic device). Operations of wrist-wearable device 1400 can be performed by watch body 1420 alone or in conjunction with wearable band 1410 (e.g., via respective processors and/or hardware components) and vice versa. In some embodiments, operations of wrist-wearable device 1400, watch body 1420, and/or wearable band 1410 can be performed in conjunction with one or more processors and/or hardware components.

As described below with reference to the block diagram of FIG. 15, wearable band 1410 and/or watch body 1420 can each include independent resources required to independently execute functions. For example, wearable band 1410 and/or watch body 1420 can each include a power source (e.g., a battery), a memory, data storage, a processor (e.g., a central processing unit (CPU)), communications, a light source, and/or input/output devices.

FIG. 15 shows block diagrams of a computing system 1530 corresponding to wearable band 1410 and a computing system 1560 corresponding to watch body 1420 according to some embodiments. Computing system 1500 of wrist-wearable device 1400 may include a combination of components of wearable band computing system 1530 and watch body computing system 1560, in accordance with some embodiments.

Watch body 1420 and/or wearable band 1410 can include one or more components shown in watch body computing system 1560. In some embodiments, a single integrated circuit may include all or a substantial portion of the components of watch body computing system 1560 included in a single integrated circuit. Alternatively, in some embodiments, components of the watch body computing system 1560 may be included in a plurality of integrated circuits that are communicatively coupled. In some embodiments, watch body computing system 1560 may be configured to couple (e.g., via a wired or wireless connection) with wearable band computing system 1530, which may allow the computing systems to share components, distribute tasks, and/or perform other operations described herein (individually or as a single device).

Watch body computing system 1560 can include one or more processors 1579, a controller 1577, a peripherals interface 1561, a power system 1595, and memory (e.g., a memory 1580).

Power system 1595 can include a charger input 1596, a power-management integrated circuit (PMIC) 1597, and a battery 1598. In some embodiments, a watch body 1420 and a wearable band 1410 can have respective batteries (e.g., battery 1598 and 1559) and can share power with each other. Watch body 1420 and wearable band 1410 can receive a charge using a variety of techniques. In some embodiments, watch body 1420 and wearable band 1410 can use a wired charging assembly (e.g., power cords) to receive the charge. Alternatively, or in addition, watch body 1420 and/or wearable band 1410 can be configured for wireless charging. For example, a portable charging device can be designed to mate with a portion of watch body 1420 and/or wearable band 1410 and wirelessly deliver usable power to battery 1598 of watch body 1420 and/or battery 1559 of wearable band 1410. Watch body 1420 and wearable band 1410 can have independent power systems (e.g., power system 1595 and 1556, respectively) to enable each to operate independently. Watch body 1420 and wearable band 1410 can also share power (e.g., one can charge the other) via respective PMICs (e.g., PMICs 1597 and 1558) and charger inputs (e.g., 1557 and 1596) that can share power over power and ground conductors and/or over wireless charging antennas.

In some embodiments, peripherals interface 1561 can include one or more sensors 1521. Sensors 1521 can include one or more coupling sensors 1562 for detecting when watch body 1420 is coupled with another electronic device (e.g., a wearable band 1410). Sensors 1521 can include one or more imaging sensors 1563 (e.g., one or more of cameras 1525, and/or separate imaging sensors 1563 (e.g., thermal-imaging sensors)). In some embodiments, sensors 1521 can include one or more SpO2 sensors 1564. In some embodiments, sensors 1521 can include one or more biopotential-signal sensors (e.g., EMG sensors 1565, which may be disposed on an interior, user-facing portion of watch body 1420 and/or wearable band 1410). In some embodiments, sensors 1521 may include one or more capacitive sensors 1566. In some embodiments, sensors 1521 may include one or more heart rate sensors 1567. In some embodiments, sensors 1521 may include one or more IMU sensors 1568. In some embodiments, one or more IMU sensors 1568 can be configured to detect movement of a user's hand or other location where watch body 1420 is placed or held.

In some embodiments, one or more of sensors 1521 may provide an example human-machine interface. For example, a set of neuromuscular sensors, such as EMG sensors 1565, may be arranged circumferentially around wearable band 1410 with an interior surface of EMG sensors 1565 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 1410 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 1579. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 1565 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 1561 includes a near-field communication (NFC) component 1569, a global-position system (GPS) component 1570, a long-term evolution (LTE) component 1571, and/or a Wi-Fi and/or Bluetooth communication component 1572. In some embodiments, peripherals interface 1561 includes one or more buttons 1573 (e.g., peripheral buttons 1423 and 1427 in FIG. 14), which, when selected by a user, cause operation to be performed at watch body 1420. In some embodiments, the peripherals interface 1561 includes one or more indicators, such as a light emitting diode (LED), to provide a user with visual indicators (e.g., message received, low battery, active microphone and/or camera, etc.).

Watch body 1420 can include at least one display 1405 for displaying visual representations of information or data to a user, including user-interface elements and/or three-dimensional virtual objects. The display can also include a touch screen for inputting user inputs, such as touch gestures, swipe gestures, and the like. Watch body 1420 can include at least one speaker 1574 and at least one microphone 1575 for providing audio signals to the user and receiving audio input from the user. The user can provide user inputs through microphone 1575 and can also receive audio output from speaker 1574 as part of a haptic event provided by haptic controller 1578. Watch body 1420 can include at least one camera 1525, including a front camera 1525a and a rear camera 1525b. Cameras 1525 can include ultra-wide-angle cameras, wide angle cameras, fish-eye cameras, spherical cameras, telephoto cameras, depth-sensing cameras, or other types of cameras.

Watch body computing system 1560 can include one or more haptic controllers 1578 and associated componentry (e.g., haptic devices 1576) for providing haptic events at watch body 1420 (e.g., a vibrating sensation or audio output in response to an event at the watch body 1420). Haptic controllers 1578 can communicate with one or more haptic devices 1576, such as electroacoustic devices, including a speaker of the one or more speakers 1574 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 1578 can provide haptic events to that are capable of being sensed by a user of watch body 1420. In some embodiments, one or more haptic controllers 1578 can receive input signals from an application of applications 1582.

In some embodiments, wearable band computing system 1530 and/or watch body computing system 1560 can include memory 1580, which can be controlled by one or more memory controllers of controllers 1577. In some embodiments, software components stored in memory 1580 include one or more applications 1582 configured to perform operations at the watch body 1420. In some embodiments, one or more applications 1582 may include games, word processors, messaging applications, calling applications, web browsers, social media applications, media streaming applications, financial applications, calendars, clocks, etc. In some embodiments, software components stored in memory 1580 include one or more communication interface modules 1583 as defined above. In some embodiments, software components stored in memory 1580 include one or more graphics modules 1584 for rendering, encoding, and/or decoding audio and/or visual data and one or more data management modules 1585 for collecting, organizing, and/or providing access to data 1587 stored in memory 1580. In some embodiments, one or more of applications 1582 and/or one or more modules can work in conjunction with one another to perform various tasks at the watch body 1420.

In some embodiments, software components stored in memory 1580 can include one or more operating systems 1581 (e.g., a Linux-based operating system, an Android operating system, etc.). Memory 1580 can also include data 1587. Data 1587 can include profile data 1588A, sensor data 1589A, media content data 1590, and application data 1591.

It should be appreciated that watch body computing system 1560 is an example of a computing system within watch body 1420, and that watch body 1420 can have more or fewer components than shown in watch body computing system 1560, can combine two or more components, and/or can have a different configuration and/or arrangement of the components. The various components shown in watch body computing system 1560 are implemented in hardware, software, firmware, or a combination thereof, including one or more signal processing and/or application-specific integrated circuits.

Turning to the wearable band computing system 1530, one or more components that can be included in wearable band 1410 are shown. Wearable band computing system 1530 can include more or fewer components than shown in watch body computing system 1560, can combine two or more components, and/or can have a different configuration and/or arrangement of some or all of the components. In some embodiments, all, or a substantial portion of the components of wearable band computing system 1530 are included in a single integrated circuit. Alternatively, in some embodiments, components of wearable band computing system 1530 are included in a plurality of integrated circuits that are communicatively coupled. As described above, in some embodiments, wearable band computing system 1530 is configured to couple (e.g., via a wired or wireless connection) with watch body computing system 1560, which allows the computing systems to share components, distribute tasks, and/or perform other operations described herein (individually or as a single device).

Wearable band computing system 1530, similar to watch body computing system 1560, can include one or more processors 1549, one or more controllers 1547 (including one or more haptics controllers 1548), a peripherals interface 1531 that can includes one or more sensors 1513 and other peripheral devices, a power source (e.g., a power system 1556), and memory (e.g., a memory 1550) that includes an operating system (e.g., an operating system 1551), data (e.g., data 1554 including profile data 1588B, sensor data 1589B, etc.), and one or more modules (e.g., a communications interface module 1552, a data management module 1553, etc.).

One or more of sensors 1513 can be analogous to sensors 1521 of watch body computing system 1560. For example, sensors 1513 can include one or more coupling sensors 1532, one or more SpO2 sensors 1534, one or more EMG sensors 1535, one or more capacitive sensors 1536, one or more heart rate sensors 1537, and one or more IMU sensors 1538.

Peripherals interface 1531 can also include other components analogous to those included in peripherals interface 1561 of watch body computing system 1560, including an NFC component 1539, a GPS component 1540, an LTE component 1541, a Wi-Fi and/or Bluetooth communication component 1542, and/or one or more haptic devices 1546 as described above in reference to peripherals interface 1561. In some embodiments, peripherals interface 1531 includes one or more buttons 1543, a display 1533, a speaker 1544, a microphone 1545, and a camera 1555. In some embodiments, peripherals interface 1531 includes one or more indicators, such as an LED.

It should be appreciated that wearable band computing system 1530 is an example of a computing system within wearable band 1410, and that wearable band 1410 can have more or fewer components than shown in wearable band computing system 1530, combine two or more components, and/or have a different configuration and/or arrangement of the components. The various components shown in wearable band computing system 1530 can be implemented in one or more of a combination of hardware, software, or firmware, including one or more signal processing and/or application-specific integrated circuits.

Wrist-wearable device 1400 with respect to FIG. 14 is an example of wearable band 1410 and watch body 1420 coupled together, so wrist-wearable device 1400 will be understood to include the components shown and described for wearable band computing system 1530 and watch body computing system 1560. In some embodiments, wrist-wearable device 1400 has a split architecture (e.g., a split mechanical architecture, a split electrical architecture, etc.) between watch body 1420 and wearable band 1410. In other words, all of the components shown in wearable band computing system 1530 and watch body computing system 1560 can be housed or otherwise disposed in a combined wrist-wearable device 1400 or within individual components of watch body 1420, wearable band 1410, and/or portions thereof (e.g., a coupling mechanism 1416 of wearable band 1410).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 1400 can be used in conjunction with a head-wearable device (e.g., AR system 1600 and VR system 1710) and/or an HIPD, and wrist-wearable device 1400 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR system 1600 and VR system 1710.

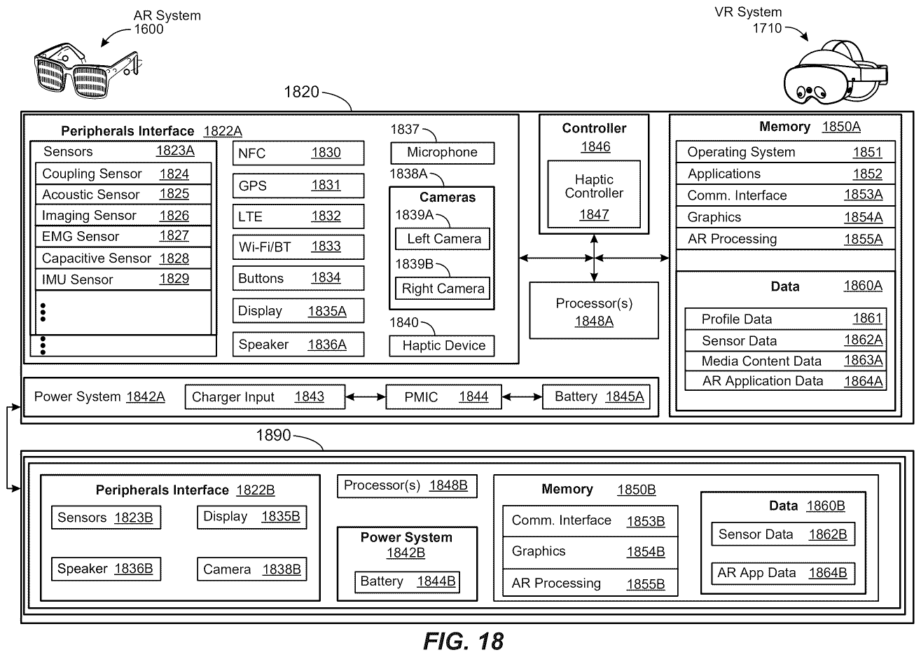

FIGS. 16 to 18 show example artificial-reality systems, which can be used as or in connection with wrist-wearable device 1400. In some embodiments, AR system 1600 includes an eyewear device 1602, as shown in FIG. 16. In some embodiments, VR system 1710 includes a head-mounted display (HMD) 1712, as shown in FIGS. 17A and 17B. In some embodiments, AR system 1600 and VR system 1710 can include one or more analogous components (e.g., components for presenting interactive artificial-reality environments, such as processors, memory, and/or presentation devices, including one or more displays and/or one or more waveguides), some of which are described in more detail with respect to FIG. 18. As described herein, a head-wearable device can include components of eyewear device 1602 and/or head-mounted display 1712. Some embodiments of head-wearable devices do not include any displays, including any of the displays described with respect to AR system 1600 and/or VR system 1710. While the example artificial-reality systems are respectively described herein as AR system 1600 and VR system 1710, either or both of the example AR systems described herein can be configured to present fully-immersive virtual-reality scenes presented in substantially all of a user's field of view or subtler augmented-reality scenes that are presented within a portion, less than all, of the user's field of view.

FIG. 16 show an example visual depiction of AR system 1600, including an eyewear device 1602 (which may also be described herein as augmented-reality glasses, and/or smart glasses). AR system 1600 can include additional electronic components that are not shown in FIG. 16, such as a wearable accessory device and/or an intermediary processing device, in electronic communication or otherwise configured to be used in conjunction with the eyewear device 1602. In some embodiments, the wearable accessory device and/or the intermediary processing device may be configured to couple with eyewear device 1602 via a coupling mechanism in electronic communication with a coupling sensor 1824 (FIG. 18), where coupling sensor 1824 can detect when an electronic device becomes physically or electronically coupled with eyewear device 1602. In some embodiments, eyewear device 1602 can be configured to couple to a housing 1890 (FIG. 18), which may include one or more additional coupling mechanisms configured to couple with additional accessory devices. The components shown in FIG. 16 can be implemented in hardware, software, firmware, or a combination thereof, including one or more signal-processing components and/or application-specific integrated circuits (ASICs).

Eyewear device 1602 includes mechanical glasses components, including a frame 1604 configured to hold one or more lenses (e.g., one or both lenses 1606-1 and 1606-2). One of ordinary skill in the art will appreciate that eyewear device 1602 can include additional mechanical components, such as hinges configured to allow portions of frame 1604 of eyewear device 1602 to be folded and unfolded, a bridge configured to span the gap between lenses 1606-1 and 1606-2 and rest on the user's nose, nose pads configured to rest on the bridge of the nose and provide support for eyewear device 1602, earpieces configured to rest on the user's ears and provide additional support for eyewear device 1602, temple arms configured to extend from the hinges to the earpieces of eyewear device 1602, and the like. One of ordinary skill in the art will further appreciate that some examples of AR system 1600 can include none of the mechanical components described herein. For example, smart contact lenses configured to present artificial reality to users may not include any components of eyewear device 1602.

Eyewear device 1602 includes electronic components, many of which will be described in more detail below with respect to FIG. 18. Some example electronic components are illustrated in FIG. 16, including acoustic sensors 1625-1, 1625-2, 1625-3, 1625-4, 1625-5, and 1625-6, which can be distributed along a substantial portion of the frame 1604 of eyewear device 1602. Eyewear device 1602 also includes a left camera 1639A and a right camera 1639B, which are located on different sides of the frame 1604. Eyewear device 1602 also includes a processor 1648 (or any other suitable type or form of integrated circuit) that is embedded into a portion of the frame 1604.

FIGS. 17A and 17B show a VR system 1710 that includes a head-mounted display (HMD) 1712 (e.g., also referred to herein as an artificial-reality headset, a head-wearable device, a VR headset, etc.), in accordance with some embodiments. As noted, some artificial-reality systems (e.g., AR system 1600) may, instead of blending an artificial reality with actual reality, substantially replace one or more of a user's visual and/or other sensory perceptions of the real world with a virtual experience (e.g., AR systems 1200 and 1300).

HMD 1712 includes a front body 1714 and a frame 1716 (e.g., a strap or band) shaped to fit around a user's head. In some embodiments, front body 1714 and/or frame 1716 include one or more electronic elements for facilitating presentation of and/or interactions with an AR and/or VR system (e.g., displays, IMUs, tracking emitter or detectors). In some embodiments, HMD 1712 includes output audio transducers (e.g., an audio transducer 1718), as shown in FIG. 17B. In some embodiments, one or more components, such as the output audio transducer(s) 1718 and frame 1716, can be configured to attach and detach (e.g., are detachably attachable) to HMD 1712 (e.g., a portion or all of frame 1716, and/or audio transducer 1718), as shown in FIG. 17B. In some embodiments, coupling a detachable component to HMD 1712 causes the detachable component to come into electronic communication with HMD 1712.

FIGS. 17A and 17B also show that VR system 1710 includes one or more cameras, such as left camera 1739A and right camera 1739B, which can be analogous to left and right cameras 1639A and 1639B on frame 1604 of eyewear device 1602. In some embodiments, VR system 1710 includes one or more additional cameras (e.g., cameras 1739C and 1739D), which can be configured to augment image data obtained by left and right cameras 1739A and 1739B by providing more information. For example, camera 1739C can be used to supply color information that is not discerned by cameras 1739A and 1739B. In some embodiments, one or more of cameras 1739A to 1739D can include an optional IR cut filter configured to remove IR light from being received at the respective camera sensors.

FIG. 18 illustrates a computing system 1820 and an optional housing 1890, each of which show components that can be included in AR system 1600 and/or VR system 1710. In some embodiments, more or fewer components can be included in optional housing 1890 depending on practical restraints of the respective AR system being described.

In some embodiments, computing system 1820 can include one or more peripherals interfaces 1822A and/or optional housing 1890 can include one or more peripherals interfaces 1822B. Each of computing system 1820 and optional housing 1890 can also include one or more power systems 1842A and 1842B, one or more controllers 1846 (including one or more haptic controllers 1847), one or more processors 1848A and 1848B (as defined above, including any of the examples provided), and memory 1850A and 1850B, which can all be in electronic communication with each other. For example, the one or more processors 1848A and 1848B can be configured to execute instructions stored in memory 1850A and 1850B, which can cause a controller of one or more of controllers 1846 to cause operations to be performed at one or more peripheral devices connected to peripherals interface 1822A and/or 1822B. In some embodiments, each operation described can be powered by electrical power provided by power system 1842A and/or 1842B.

In some embodiments, peripherals interface 1822A can include one or more devices configured to be part of computing system 1820, some of which have been defined above and/or described with respect to the wrist-wearable devices shown in FIGS. 14 and 15. For example, peripherals interface 1822A can include one or more sensors 1823A. Some example sensors 1823A include one or more coupling sensors 1824, one or more acoustic sensors 1825, one or more imaging sensors 1826, one or more EMG sensors 1827, one or more capacitive sensors 1828, one or more IMU sensors 1829, and/or any other types of sensors explained above or described with respect to any other embodiments discussed herein.

In some embodiments, peripherals interfaces 1822A and 1822B can include one or more additional peripheral devices, including one or more NFC devices 1830, one or more GPS devices 1831, one or more LTE devices 1832, one or more Wi-Fi and/or Bluetooth devices 1833, one or more buttons 1834 (e.g., including buttons that are slidable or otherwise adjustable), one or more displays 1835A and 1835B, one or more speakers 1836A and 1836B, one or more microphones 1837, one or more cameras 1838A and 1838B (e.g., including the left camera 1839A and/or a right camera 1839B), one or more haptic devices 1840, and/or any other types of peripheral devices defined above or described with respect to any other embodiments discussed herein.

AR systems can include a variety of types of visual feedback mechanisms (e.g., presentation devices). For example, display devices in AR system 1600 and/or VR system 1710 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 1835A and 1835B can be coupled to each of the lenses 1606-1 and 1606-2 of AR system 1600. Displays 1835A and 1835B may be coupled to each of lenses 1606-1 and 1606-2, which can act together or independently to present an image or series of images to a user. In some embodiments, AR system 1600 includes a single display 1835A or 1835B (e.g., a near-eye display) or more than two displays 1835A and 1835B. In some embodiments, a first set of one or more displays 1835A and 1835B can be used to present an augmented-reality environment, and a second set of one or more display devices 1835A and 1835B can be used to present a virtual-reality environment. In some embodiments, one or more waveguides are used in conjunction with presenting artificial-reality content to the user of AR system 1600 (e.g., as a means of delivering light from one or more displays 1835A and 1835B to the user's eyes). In some embodiments, one or more waveguides are fully or partially integrated into the eyewear device 1602. Additionally, or alternatively to display screens, some artificial-reality systems include one or more projection systems. For example, display devices in AR system 1600 and/or VR system 1710 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 1835A and 1835B.

Computing system 1820 and/or optional housing 1890 of AR system 1600 or VR system 1710 can include some or all of the components of a power system 1842A and 1842B. Power systems 1842A and 1842B can include one or more charger inputs 1843, one or more PMICs 1844, and/or one or more batteries 1845A and 1844B.

Memory 1850A and 1850B may include instructions and data, some or all of which may be stored as non-transitory computer-readable storage media within the memories 1850A and 1850B. For example, memory 1850A and 1850B can include one or more operating systems 1851, one or more applications 1852, one or more communication interface applications 1853A and 1853B, one or more graphics applications 1854A and 1854B, one or more AR processing applications 1855A and 1855B, and/or any other types of data defined above or described with respect to any other embodiments discussed herein.

Memory 1850A and 1850B also include data 1860A and 1860B, which can be used in conjunction with one or more of the applications discussed above. Data 1860A and 1860B can include profile data 1861, sensor data 1862A and 1862B, media content data 1863A, AR application data 1864A and 1864B, and/or any other types of data defined above or described with respect to any other embodiments discussed herein.

In some embodiments, controller 1846 of eyewear device 1602 may process information generated by sensors 1823A and/or 1823B on eyewear device 1602 and/or another electronic device within AR system 1600. For example, controller 1846 can process information from acoustic sensors 1625-1 and 1625-2. For each detected sound, controller 1846 can perform a direction of arrival (DOA) estimation to estimate a direction from which the detected sound arrived at eyewear device 1602 of AR system 1600. As one or more of acoustic sensors 1825 (e.g., the acoustic sensors 1625-1, 1625-2) detects sounds, controller 1846 can populate an audio data set with the information (e.g., represented in FIG. 18 as sensor data 1862A and 1862B).

In some embodiments, a physical electronic connector can convey information between eyewear device 1602 and another electronic device and/or between one or more processors 1648, 1848A, 1848B of AR system 1600 or VR system 1710 and controller 1846. The information can be in the form of optical data, electrical data, wireless data, or any other transmittable data form. Moving the processing of information generated by eyewear device 1602 to an intermediary processing device can reduce weight and heat in the eyewear device, making it more comfortable and safer for a user. In some embodiments, an optional wearable accessory device (e.g., an electronic neckband) is coupled to eyewear device 1602 via one or more connectors. The connectors can be wired or wireless connectors and can include electrical and/or non-electrical (e.g., structural) components. In some embodiments, eyewear device 1602 and the wearable accessory device can operate independently without any wired or wireless connection between them.

In some situations, pairing external devices, such as an intermediary processing device (e.g., HIPD 1006, 1106, 1206) with eyewear device 1602 (e.g., as part of AR system 1600) enables eyewear device 1602 to achieve a similar form factor of a pair of glasses while still providing sufficient battery and computation power for expanded capabilities. Some, or all, of the battery power, computational resources, and/or additional features of AR system 1600 can be provided by a paired device or shared between a paired device and eyewear device 1602, thus reducing the weight, heat profile, and form factor of eyewear device 1602 overall while allowing eyewear device 1602 to retain its desired functionality. For example, the wearable accessory device can allow components that would otherwise be included on eyewear device 1602 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 1602 standing alone. Because weight carried in the wearable accessory device can be less invasive to a user than weight carried in the eyewear device 1602, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1600 and/or VR system 1710 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 17A and 17B show VR system 1710 having cameras 1739A to 1739D, which can be used to provide depth information for creating a voxel field and a two-dimensional mesh to provide object information to the user to avoid collisions.

In some embodiments, AR system 1600 and/or VR system 1710 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1600 and/or VR system 1710, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

What is claimed is:

1. An ophthalmic lens assembly comprising:
a transparent ophthalmic substrate; and
a transparent conductive coating on the substrate, wherein:
the transparent conductive coating is patterned into at least one conductive island that:
is configured as an electrode;
comprises a non-geometrically defined shape; and
is separated from adjacent conductive material by an insulating gap.

2. The ophthalmic lens assembly of claim 1, wherein the transparent ophthalmic substrate comprises a planar lens formed of at least one of glass or polycarbonate.

3. The ophthalmic lens assembly of claim 1, wherein the transparent ophthalmic substrate provides an average visible transmission of at least 90% for light with wavelengths between 400 and 750 nanometers.

4. The ophthalmic lens assembly of claim 1, wherein the transparent ophthalmic substrate comprises a thickness less than 500 micrometers.

5. The ophthalmic lens assembly of claim 4, wherein the transparent conductive coating has a thickness between approximate 100 nanometers and 150 nanometers.

6. The ophthalmic lens assembly of claim 1, wherein the transparent conductive coating has a sheet resistance less than 15 ohms per square.

7. The ophthalmic lens assembly of claim 1, wherein the insulating gap comprises variable-width spacing between the adjacent conductive material.

8. The ophthalmic lens assembly of claim 1, wherein each curve of the at least one conductive island comprises a minimum radius of curvature greater than 2 micrometers along a boundary of the conductive island.

9. The ophthalmic lens assembly of claim 1, wherein a total area of the insulating gap between adjacent conductive islands is less than 5% of an area of a corresponding conductive island.

10. The ophthalmic lens assembly of claim 1, further comprising at least one electronic component electrically coupled to the at least one conductive island.

11. The ophthalmic lens assembly of claim 10, wherein the at least one electronic component is configured to operate with at least one of:
direct current, or
pulsed current having a frequency less than 10 Hz.

12. The ophthalmic lens assembly of claim 11, wherein the at least one electronic component is bonded to the at least one conductive island by metal-to-metal flip-chip bonding between respective metal bond pads.

13. The ophthalmic lens assembly of claim 1, further comprising an adhesive layer between the transparent ophthalmic substrate and the transparent conductive coating, the adhesive layer comprising titanium.

14. A method of manufacturing an ophthalmic lens assembly comprising:
providing a transparent ophthalmic substrate;
patterning a transparent conductive coating on the substrate in a manner that defines at least one conductive island configured as an electrode, the at least one conductive island comprising a non-geometrically defined shape; and
creating at least one adjacent conductive island in a manner that leaves an insulating gap between conductive regions.

15. The method of claim 14, further comprising depositing an adhesive layer comprising titanium between the transparent ophthalmic substrate and the transparent conductive coating prior to patterning.

16. The method of claim 14, wherein patterning defines a boundary of each conductive island with a minimum local radius of curvature greater than 2 micrometers and creating leaves variable-width insulating gaps whose total area is less than 5% of a corresponding island area.

17. The method of claim 14, further comprising filling the insulating gap with an index-matching material, wherein the transparent conductive coating comprises a thickness between approximately 100 and 150 nanometers and achieves a sheet resistance less than 15 ohms per square.

18. An eyewear device comprising:
a frame supporting;
at least one ophthalmic lens assembly comprising:
a transparent ophthalmic substrate, and
a transparent conductive coating on the substrate, the transparent conductive coating patterned into at least one conductive island configured as an electrode, the at least one conductive island having a non-geometrically defined shape and being separated from adjacent conductive material by an insulating gap in a manner that provides electrical isolation while maintaining see-through transparency in a wearer's field of view.

19. The eyewear device of claim 18, wherein boundaries of the at least one conductive island have a minimum local radius of curvature greater than 2 micrometers and the insulating gap has variable width with a total area less than 5% of an area of a corresponding conductive island.

20. The eyewear device of claim 18, wherein:
the insulating gap is filled with an index-matching material;
the transparent conductive coating has a thickness between approximately 100 and 150 nanometers with a sheet resistance less than 15 ohms per square; and
further comprising at least one electronic component that is flip-chip bonded to the at least one conductive island via metal bond pads.
